(19) United States
(12) Patent Application Publication
(10) Pub. No.: US 2026/0290314 A1
(43) Pub. Date: Sep. 24, 2026

(54) SYSTEM

(71) Applicant: SoftBank Group Corp., Tokyo (JP)

(72) Inventor: Yumiko ASADA, Tokyo (JP)

(73) Assignee: SoftBank Group Corp., Tokyo (JP)

(21) Appl. No.: 19/568,870

(22) Filed: Mar. 17, 2026

(30) Foreign Application Priority Data
Mar. 19, 2025 (JP) 2025-045267

(51) Int. Cl. G10L 13/047; G06F 40/20; G06N 3/0475

(52) U.S. Cl. CPC G10L 13/047; G06F 40/20; G06N 3/0475

(57) ABSTRACT

A system includes a processor that is configured to obtain post data by using an application programming interface of an information-sharing platform to collect posts of specific users of the information-sharing platform during a disaster, analyze the collected posts and extract important information from the collected posts by using natural language processing techniques, and convert the extracted important information into audio by converting text data into audio data by using a speech synthesis technique and transmit the audio data over a wireless communication link.

### CROSS-REFERENCE TO RELATED APPLICATION

This application is based on and claims priority under 35 USC 119 from Japanese Patent Application No. 2025-045267 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information distribution systems during disasters typically rely on manual curation, static broadcasting, and non-personalized channels such as television, radio, or simple push notifications. As a result, users often receive large volumes of undifferentiated information, which makes it difficult for them to quickly identify information that is personally important, such as information related to their own region, interests, or psychological state. In addition, conventional systems generally do not leverage real-time posts from specific influential users on information-sharing platforms, nor do they systematically extract important information from such posts by using natural language processing. Furthermore, existing systems rarely convert such extracted information into audio in a unified manner and distribute it wirelessly in near real time. Consequently, users may miss critical information or experience information overload, particularly under stressful conditions during disasters. Moreover, conventional systems do not sufficiently use generative artificial intelligence models to optimize the content to be distributed based on user profile data such as interests, regional characteristics, and persona, and do not use emotion analysis of user posts and reactions to dynamically adjust distribution content according to the emotional state of each user. Therefore, there is a need for a system that can automatically collect posts from specific users on an information-sharing platform during a disaster, extract important information from the posts, convert the important information into audio for wireless distribution, and further personalize and dynamically adjust the distribution content by using generative artificial intelligence and emotion analysis based on user profiles and reactions.

### SUMMARY

In order to solve the above-described problems, a system according to one aspect of the present invention comprises a processor, wherein the processor is configured to obtain post data by using an application programming interface of an information-sharing platform to collect posts of specific users of the information-sharing platform during a disaster, analyze the collected posts and extract important information from the collected posts by using natural language processing techniques, and convert the extracted important information into audio by converting text data into audio data by using a speech synthesis technique and transmit the audio data over a wireless communication link. According to another aspect, the processor is configured to refer to profile data of a user, including at least interests of the user, regional characteristics of the user, and a persona of the user, and generate a prompt for instructing a generative artificial intelligence model to optimize distribution content, in order to adjust the distribution content based on the profile data. According to still another aspect, the processor is configured to extract emotion data from posts and reactions of a user by using an emotion analysis algorithm, and generate a prompt for instructing dynamic adjustment of distribution content based on the extracted emotion data. By combining these configurations, the system automatically collects posts during disasters, extracts important information, converts the information into audio for wireless distribution, and further optimizes and dynamically adjusts the distribution content per user by using generative artificial intelligence and emotion analysis, thereby enabling timely, personalized, and emotionally adaptive information delivery in disaster situations.

The term “system” refers to an arrangement including at least one processor and, optionally, one or more memory units, communication interfaces, and other hardware or software components that cooperate to perform the functions described in the claims.

The term “processor” refers to any hardware device or combination of hardware devices capable of executing instructions, such as a central processing unit (CPU), a microprocessor, a digital signal processor (DSP), a graphics processing unit (GPU), an application specific integrated circuit (ASIC), a field programmable gate array (FPGA), or a combination thereof.

The term “information-sharing platform” refers to an electronic service or network that enables users to post, share, and view information, including text, images, audio, or video, such as a social networking service, a microblogging service, or a similar online platform.

The term “post” refers to a unit of content submitted by a user to an information-sharing platform, including at least text data and optionally additional data such as metadata, images, audio, video, or links.

The term “specific users” refers to one or more users that are designated in advance or dynamically selected based on predetermined criteria, such as celebrity status, verified account status, official role, or influence level on an information-sharing platform.

The term “disaster” refers to an event or situation that poses a significant threat to human life, health, property, infrastructure, or the environment, including but not limited to natural disasters, technological accidents, and large-scale emergencies.

The term “application programming interface” or “API” refers to a defined interface provided by an information-sharing platform that allows external systems to programmatically access, retrieve, or manipulate data, such as post data, via specified requests and responses.

The term “post data” refers to data obtained from an information-sharing platform relating to one or more posts, including at least the text content and optionally associated metadata such as timestamps, user identifiers, and reaction counts.

The term “natural language processing techniques” refers to computational methods and algorithms for analyzing, interpreting, and processing human language in textual form, including techniques such as tokenization, part-of-speech tagging, named entity recognition, classification, summarization, and keyword extraction.

The term “important information” refers to information that is determined to be significant or relevant according to one or more criteria, including but not limited to disaster-related content, urgency, geographic relevance, or user-specific relevance derived from natural language processing of post data.

The term “speech synthesis technique” refers to a method or system for generating audio signals that represent spoken language from text data, including but not limited to text-to-speech (TTS) engines implemented in software, hardware, or a combination thereof.

The term “text data” refers to data representing information in a character-based or string-based format suitable for processing by natural language processing or speech synthesis systems.

The term “audio data” refers to digital data representing sound, including encoded or unencoded samples of speech signals that can be transmitted, stored, and reproduced by audio playback devices.

The term “wireless communication link” refers to any communication path that transmits data without a physical wired connection, including but not limited to cellular networks, Wi-Fi networks, satellite links, or other radio-frequency communication systems.

The term “distribution content” refers to information that is selected, generated, or adapted by the system for delivery to a user, including but not limited to audio representations of important information extracted from posts and any additional information produced by generative artificial intelligence models.

The term “profile data of a user” refers to data stored in association with a user that describes characteristics of the user, including at least the interests of the user, regional characteristics of the user, and a persona of the user, and optionally other attributes such as age, language, or device type.

The term “interests of the user” refers to topics, categories, or fields that the user prefers or is likely to pay attention to, such as hobbies, professional fields, or thematic preferences, as indicated explicitly by the user or inferred from user behavior.

The term “regional characteristics of the user” refers to information related to the geographic location or area associated with the user, such as city, region, country, or typical movement area, or attributes derived from such geographic information.

The term “persona of the user” refers to a characterization or profile of the user's typical behavior, preferences, or psychological traits, which may include, for example, an “anxious” persona, a “calm” persona, or other types used to guide personalization of distribution content.

The term “generative artificial intelligence model” refers to a machine learning model configured to generate new content, such as text or other data, based on input prompts, including but not limited to large language models, generative adversarial networks, or transformer-based generative models.

The term “prompt” refers to an input instruction, query, or context string provided to a generative artificial intelligence model, which guides or constrains the content generated by the generative artificial intelligence model.

The term “emotion analysis algorithm” refers to an algorithm or set of algorithms configured to detect, classify, or quantify emotional states or sentiments from input data, such as text of posts or reactions, by using techniques including but not limited to sentiment analysis, emotion classification, or affective computing methods.

The term “emotion data” refers to data representing an estimated or detected emotional state, sentiment, or affective characteristic derived from user posts or reactions, such as indications of anxiety, fear, relief, or neutrality.

The term “reactions of a user” refers to responses by a user to distributed content, including but not limited to likes, ratings, comments, or other feedback actions that can be recorded by the system and associated with particular posts or pieces of distribution content.

The term “dynamic adjustment of distribution content” refers to modifying, in real time or near real time, at least one aspect of the content to be distributed, such as selection, ordering, frequency, or style, based on changing conditions, including user emotion data, updated profile data, or recent user reactions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

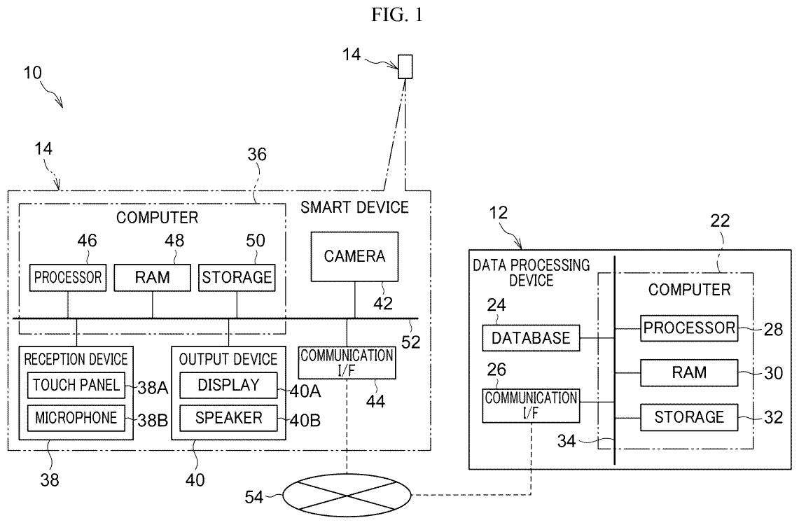

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

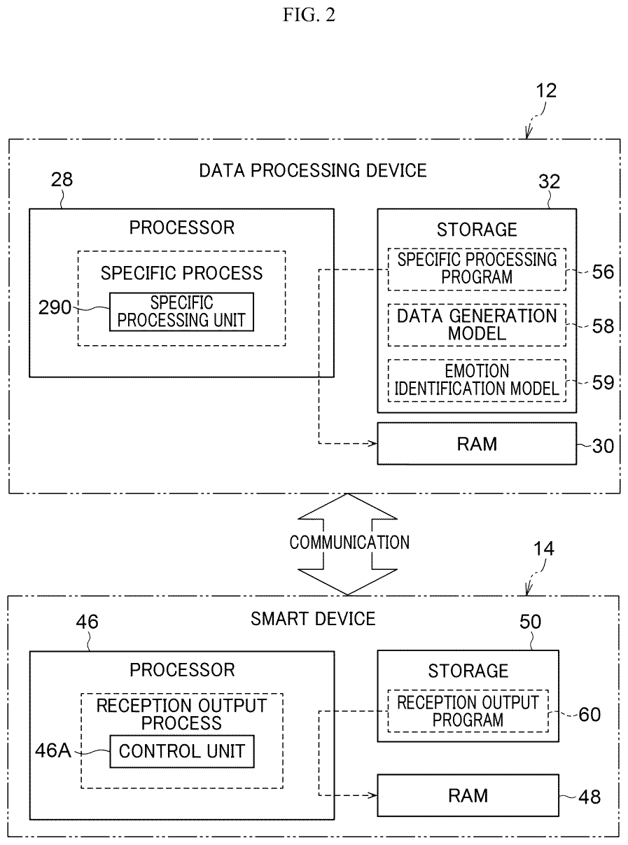

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In disaster situations, decision makers increasingly depend on digital information sharing services to obtain situational awareness and to coordinate response actions. Conventional systems typically collect posts from such services and display them as raw or lightly filtered text streams. These systems suffer from several technical problems: they rely on manual review of large volumes of unstructured text, they provide limited support for automated identification of critical events, and they do not adapt the presented information or analytics to the particular informational needs or cognitive state of an individual user. As a result, the computing resources of the system are not effectively used to prioritize processing and presentation of the most relevant disaster information. Latency increases, operator workload is high, and it is difficult for the system to deliver concise, context-aware guidance in real time.

Furthermore, existing architectures generally treat natural language processing and machine learning models as isolated components. Raw posts may be subject to basic keyword matching, but are not consistently converted into structured, queryable representations that can drive efficient storage, retrieval, and higher-level analytics. In particular, there is no integrated mechanism whereby structured disaster information, rich user attribute information, and prompt sentences provided by the user are combined to generate optimized instruction information for a generative AI model. Without such a mechanism, the generative AI model is often invoked with generic prompts and unstructured context, leading to redundant computation, suboptimal responses, and difficulty in scaling to large volumes of disaster-related data.

In addition, conventional systems do not dynamically tailor the analysis and presentation based on user emotion or stress, and therefore cannot adapt the level of detail, urgency, and explanation style of generated outputs to the user's current state. This lack of adaptive control over the interaction between the user and the generative AI model can lead to cognitive overload, misunderstanding of critical recommendations, and inefficient utilization of computational resources for generating responses that are either too detailed or too abstract for the situation.

Accordingly, there is a need for an improved computer-implemented system that: (i) automatically acquires and analyzes disaster-related posts from information sharing services and converts them into structured information with disaster type, location, damage content, and urgency; (ii) efficiently stores and retrieves this structured information for real-time aggregation and visualization; and (iii) generates optimized prompt sentences and instruction information to control a generative AI model based on user attributes, behavior, and emotional state. Such a system should improve the functioning of the underlying computer system by reducing the amount of irrelevant data presented to the user, prioritizing processing of critical data, and enabling the generative AI model to produce context-aware, user-tailored outputs with reduced computational overhead and improved response utility.

The specific processing by the specific processing unit 290 of the data processing device 12 in Example 1 is realized by the following means.

The present invention provides a server comprising a processor configured to continuously acquire, via a communication interface, post information data from an information sharing service in the event of a disaster by using a public application programming interface, to execute natural language processing on text information included in the post information data so as to generate structured information including at least a disaster type, an affected location, a damage content, and an urgency level, to store the structured information in association with time information, identification information, and position information in a storage device in a format that is directly searchable, to perform aggregation processing, classification processing, and visualization data generation processing on the structured information so as to generate disaster information display data for delivery to a user terminal, and to generate instruction information for a generative AI model based on the structured information and a prompt sentence received from a user, the processor being further configured to refer to user attribute information and emotion analysis information so as to adapt the prompt sentence and the instruction information to a field of interest, a behavioral characteristic, and an emotional state of the user before causing the generative AI model to execute additional analysis and returning a generated result to the user terminal. This enables an improvement in the functioning of the computer system by transforming unstructured disaster-related text into structured, machine-optimized representations that support efficient querying and visualization, by dynamically controlling the interaction with the generative AI model through tailored prompt sentences and instruction information, and by reducing processing of non-critical data and non-useful model outputs, thereby lowering computational overhead, decreasing response latency, and enhancing the relevance and usability of the information presented to the user during disaster response.

The term “disaster” refers to an event or condition, such as a natural or man-made incident, that significantly disrupts normal life, infrastructure, or services and requires rapid information gathering and response.

The term “information sharing service” refers to an online communication platform or network service that allows multiple users to post, distribute, and access user-generated information, including text messages related to ongoing events.

The term “post information” refers to data representing a user-submitted message on an information sharing service, including at least text content and optionally metadata such as a timestamp, a user identifier, and location-related information.

The term “public application programming interface” refers to an externally accessible programmatic interface provided by a service, through which a computing device can automatically request, receive, or send data according to predefined communication protocols and formats.

The term “communication interface” refers to hardware and software components that enable a computing device to send and receive data over a communication network using wired or wireless transmission technologies.

The term “post information data” refers to a set of digital data elements obtained from an information sharing service via the public application programming interface, including one or more instances of post information.

The term “natural language processing” refers to computerized analysis and transformation of human language text, including, for example, tokenization, part-of-speech tagging, syntactic or semantic analysis, and extraction of meaningful features.

The term “structured information” refers to data that has been organized into defined fields or attributes, such as disaster type, affected location, damage content, and urgency level, so that it can be efficiently stored, searched, and processed by a computing device.

The term “disaster type” refers to a classification label assigned to structured information to indicate a category of disaster, such as a flood, fire, or earthquake, as inferred from the content of post information.

The term “affected location” refers to location-related information, such as a geographic area, facility, or region, that is identified as being impacted by a disaster in the structured information.

The term “damage content” refers to a description or categorization of harm, loss, or disruption, such as infrastructure damage, blocked transportation routes, or service outages, derived from analysis of the post information.

The term “urgency level” refers to an indication of the degree of time-criticality or severity of a situation, such as high, medium, or low urgency, determined based on the content and context of the post information.

The term “storage device” refers to a physical or virtual data storage component, such as a non-volatile memory device or a database system, used to record and maintain structured information for later retrieval and processing.

The term “time information” refers to data that represents a temporal attribute associated with post information or structured information, such as a creation time, an update time, or a time interval.

The term “identification information” refers to one or more data elements used to distinguish or uniquely identify an item of post information or structured information, such as a post identifier, a record identifier, or a user identifier.

The term “position information” refers to data representing a geographic position or area, such as coordinates, addresses, or region identifiers, associated with post information or structured information.

The term “searchable format” refers to a data organization and storage structure that allows a computing device to efficiently retrieve records based on query conditions applied to fields such as time, location, or disaster type.

The term “aggregation processing” refers to computation that summarizes multiple items of structured information into higher-level metrics or counts, such as totals per region or averages per time period.

The term “classification processing” refers to computation that assigns one or more categories or labels to structured information according to predefined criteria or learned models, such as categorizing incidents by disaster type or severity.

The term “visualization data generation processing” refers to computation that creates data structures suitable for graphical presentation, such as lists, charts, or map overlays, from structured information or aggregated information.

The term “disaster information display data” refers to processed digital data that describes disaster-related information in a form suitable for visual presentation, including at least list information, statistical information, and geographic information.

The term “user terminal” refers to an end-user computing device, such as a smartphone, tablet, or personal computer, capable of communicating with the server and presenting disaster information display data to a user.

The term “prompt sentence” refers to a text input provided by a user that expresses an analysis request, question, or instruction used to guide processing by a generative AI model.

The term “generative AI model” refers to a machine learning model configured to produce new text or other content as an output, based on input data including at least a prompt sentence and context information.

The term “instruction information” refers to control data generated by the server that specifies how a generative AI model should process input information, including constraints such as analysis target conditions and output format conditions.

The term “additional analysis” refers to further processing performed by the generative AI model, based on structured information and a prompt sentence, to produce outputs such as summaries, prioritizations, or recommendations.

The term “support policy” refers to a set of recommended actions, priorities, or strategies for responding to a disaster situation, generated as part of the additional analysis.

The term “user attribute information” refers to data associated with a user, including at least attribute information, behavior history information, and location information, that characterizes the user's profile and context.

The term “attribute information” refers to static or relatively stable user-related data, such as demographic information, role, or affiliation, that can influence what information is relevant to the user.

The term “behavior history information” refers to records of prior user actions, such as accessed content, issued queries, or interaction patterns with the system.

The term “location information” refers to data indicating a physical or logical location associated with the user, such as current position, usual activity area, or assigned jurisdiction.

The term “field of interest” refers to a topic, category, or domain that is particularly relevant to or preferred by a user, inferred from user attribute information or behavior history information.

The term “behavioral characteristic” refers to a pattern or tendency in how a user interacts with the system, such as preferred detail level, frequency of use, or types of queries typically issued.

The term “emotion analysis information” refers to data representing an estimated emotional or stress state of a user, derived from analysis of user transmission information or operation history.

The term “emotional state index” refers to a quantitative or qualitative indicator of the user's emotional condition, such as levels of anxiety, urgency perception, or calmness, obtained via emotion analysis processing.

In one embodiment, a server includes at least one processor, a main memory, a non-volatile storage device, and a network interface. The server executes an operating system such as a UNIX-like operating system and an application stack implemented, for example, in a high-level programming language. The server communicates with at least one terminal via a wired or wireless communication network. The terminal includes a display device, an input device, a communication interface, and a web browser or dedicated client application. A user operates the terminal to access a web-based dashboard and to input a prompt sentence to request additional analysis by a generative AI model.

The server acquires post information from an information sharing service by using a public application programming interface. In a concrete example, the server uses a library such as a streaming client library (for example, a Python-based library similar to Tweepy) executed on the processor to establish a persistent HTTPS connection to an API endpoint provided by the information sharing service. The server transmits authentication information such as an API key and an access token through the network interface. The server receives, via this connection, a continuous stream of post information data in a structured format such as JSON. Each JSON object includes a text field, a timestamp field, a user identifier field, and optionally a geographic coordinate field or a region identifier field. The server converts each JSON object into an internal data record in memory, for example, a key-value structure stored in main memory, and assigns an internal record identifier.

The server applies natural language processing to the text fields of the internal data records. In one practical implementation, the server loads a language processing library such as spaCy or another tokenization and named entity recognition library into memory. The server uses the processor to perform tokenization, part-of-speech tagging, lemma extraction, and named entity recognition on the text. The server identifies entities corresponding to geographic locations, organizations, and incident descriptors. The server also computes feature vectors for each post, for example, by calculating term frequency-inverse document frequency (TF-IDF) scores for disaster-related terms, and by computing sentence embeddings using a transformer-based encoder such as a pre-trained encoder-only neural network.

The server determines structured information including a disaster type, an affected location, a damage content, and an urgency level by applying classification algorithms to these feature vectors. In one example, the server uses a multi-class classifier implemented with a gradient-boosted decision tree algorithm or a neural network classifier. The server inputs the feature vector into the classifier and obtains probability values for multiple disaster types (e.g., flood, fire, earthquake, landslide), then selects the type with the highest probability above a predefined threshold. The server determines the affected location by selecting location entities detected in the named entity recognition stage and by mapping textual place names to geographic coordinates using a mapping table stored in the non-volatile storage device. The server determines the damage content by extracting phrases that match domain-specific patterns, such as patterns describing infrastructure damage, blocked transportation routes, or human impact, using a rules engine that evaluates dependency parse trees and part-of-speech tags. The server computes the urgency level by combining a sentiment score (for example, produced by a classifier trained on labeled urgency data) and specific lexical cues such as “immediately,” “trapped,” “cannot escape,” which are represented as binary or weighted features in the feature vector.

The server stores the structured information in a storage device such as a document-oriented database (for example, a database similar to MongoDB) or a relational database. The server uses a database driver (for example, a driver similar to a Python-based client library) to write records to the storage device via the network interface or a local inter-process communication channel. Each record includes at least: a record identifier, time information, identification information corresponding to the source post, position information (coordinates or region identifiers), the determined disaster type, the affected location, the damage content, and the urgency level. The server also stores indexes on fields such as time, disaster type, and region. By creating composite indexes on, for example, (disaster type, urgency level, timestamp), the server enables efficient range queries and reduces disk access operations, thereby improving query performance and decreasing latency in dashboard updates.

The server generates disaster information display data based on the structured information stored in the storage device. When the server receives a retrieval request from the terminal, the server executes aggregation processing and classification processing using database aggregation pipelines or in-memory computations. For example, the server counts the number of high-urgency incidents per administrative region within a recent time window, calculates time-series statistics such as incident frequency per 10-minute interval, and groups incidents by disaster type. The server then constructs visualization data structures such as arrays of geographic coordinates with associated severity values and time-series vectors for plotting line charts. These visualization data structures are encoded as structured responses (for example, JSON responses) and transmitted via the network interface to the terminal. This arrangement allows the server to offload graphical rendering to the terminal while performing data-intensive aggregation on the server side, improving the technical efficiency of data distribution and reducing redundant rendering computations across multiple terminals.

The terminal receives the disaster information display data from the server and uses a web browser or a dedicated client application to render the information on the display device. The terminal draws a map view and overlays incident markers using the geographic coordinates and severity values. The terminal also draws tables and charts using list data and aggregated values received from the server. The user observes these visualizations and interacts with the interface by selecting filters, adjusting time ranges, and focusing on particular regions. The terminal sends these filter parameters back to the server through new requests. The combination of server-side aggregation and terminal-side rendering reduces the amount of data transmitted for each update, because the server can send only incremental or aggregated data instead of sending all raw post texts.

The server further generates instruction information for a generative AI model based on the structured information and a prompt sentence provided by the user. The generative AI model may be implemented as a multi-layer transformer neural network including an embedding layer, multiple self-attention layers, feedforward layers, and a final output layer. The server stores model access parameters such as model identifiers and access keys in a configuration storage area. The server receives a prompt sentence from the terminal, such as “Please summarize the most critical disaster reports from the last 30 minutes in the northern area of the city.” or “Based on the latest data, which areas should be prioritized for evacuation support?”. The terminal sends this prompt sentence to the server, and the server parses the text to identify optional time or region constraints expressed by the user.

The server retrieves a subset of structured information records from the storage device according to the parsed constraints and according to system-defined constraints, such as a maximum number of records or a maximum token count allowed for the generative AI model. The server uses ranking rules to select the most informative records, for example, by sorting by urgency level, recency, and diversity of affected locations. The server then converts the structured information into a compact textual context by generating template-based sentences, such as “At [time], in [location], there was a [disaster type] with [damage content], urgency: [urgency level].” The server concatenates a limited number of such context sentences, ensuring that the total token count remains under a configured threshold. This controlled context construction substantially reduces the amount of data transmitted to the generative AI model and reduces the computational load required for inference, while preserving key information relevant to the user query.

The server also refers to user attribute information and emotion analysis information when generating the instruction information. In one embodiment, the server maintains a user attribute database that includes attributes such as role (for example, “emergency operator” or “local resident”), typical area of responsibility, and preferred language complexity. The server maintains logs of user behavior history, including previously accessed views and past prompt sentences. The server performs emotion analysis by applying a classifier to user text inputs and user interaction patterns; for example, the server computes feature vectors based on word usage in user messages and interaction speed, then applies a neural network or support vector machine classifier trained to output an emotional state index indicating stress or urgency perception.

The server uses the user attribute information and the emotional state index to adjust the prompt sentence and the instruction information. For instance, when the user is an emergency operator and the emotional state index indicates high stress, the server constructs instruction information specifying that the generative AI model should produce concise, prioritized bullet points with explicit call-to-action statements, and should avoid lengthy explanatory paragraphs. When the user is a local resident and the emotional state index indicates confusion but not extreme stress, the server instructs the generative AI model to produce step-by-step guidance and to include definitions of technical terms. The server encodes such instructions as metadata in the instruction information, for example, by including explicit specification of desired output style, maximum length, and priority criteria. This procedure goes beyond mere human decision-making by defining machine-enforceable constraints that modulate the generative model's decoding process, resulting in more efficient use of computational resources and more relevant output for the given user context.

The server transmits the instruction information, including the reformulated prompt sentence and the context constructed from structured information, to the generative AI model via a model interface. In one embodiment, the server communicates with a remote model-serving system through an HTTPS API. The server formats the input as a sequence of messages (for example, a “system” instruction, a “context” section, and a “user” question) and sends this sequence as a request body. The model-serving system executes the transformer network, which computes a distribution over possible next tokens at each decoding step using attention scores and learned weight matrices. The model uses a decoding algorithm such as beam search or nucleus sampling to generate an output sequence that satisfies the constraints encoded in the instruction information. The server receives the generated output and parses it into one or more structured parts, such as a summary section, a prioritized area list, and optional recommendations.

The server sends the generated output to the terminal as part of the response data. The terminal displays the generated text in a designated panel, along with the existing visualizations, so that the user can view both the underlying data and the AI-generated recommendations. The user can then issue a follow-up prompt sentence, such as “Now focus only on areas where people are stranded.” or “Compare the current situation with the situation 3 hours ago.” The server repeats the procedure: it parses the new prompt sentence, retrieves and ranks relevant structured information, constructs a context, adjusts the instruction information according to updated user attributes and emotional state, and obtains another generative output. This iterative interaction leverages the structured information and adaptive instruction generation to perform context-sensitive inference that would be impractical to carry out manually, particularly under strict time constraints in disaster response.

The use of structured information and index-based retrieval yields concrete technical effects. Because the server converts unstructured text into structured fields at ingestion time and stores them in indexed databases, later queries operate on compact, indexed fields rather than full-text search across raw posts. This reduces I/O operations and CPU cycles for large-scale queries, which improves response time for dashboard updates and for building contexts for the generative AI model. The ranking and context-limiting algorithm reduces the number of tokens processed by the transformer network, thus reducing memory usage and inference time at the model-serving layer. The adaptive instruction generation based on user attributes and emotional state prevents the model from generating overly verbose or irrelevant outputs; the server constrains the model toward outputs that contain a limited set of actionable elements, which decreases overall token generation and reduces bandwidth consumption between the server and the model-serving system.

The server also implements rule-based post filtering and prioritization that differ from conventional human-centric processing. For example, the server applies threshold rules where only posts whose urgency score exceeds a specific numeric threshold and whose affected location overlaps predefined critical infrastructure zones are considered for high-priority analysis. The server can also apply non-linear scoring functions that combine multiple factors such as urgency, post density in the same region, and historical frequency to detect anomalous patterns. Such scoring functions may be implemented using parameterized formulas stored in the configuration storage, allowing tuning based on empirical performance. These algorithmic rules enable the server to automatically channel limited computational resources to records with the highest potential impact, thereby improving both technical efficiency and the quality of situational awareness.

In another embodiment, the server executes the generative AI model locally instead of delegating to a remote model-serving system. The server loads the model weights into high-speed memory and performs inference on a graphics processing unit. The server partitions the computation into batches of prompt sentences or context sets, using dynamic batching to maximize GPU utilization. The server may store an intermediate cache of encoder outputs for frequently used context segments, such as static background information about a region, and reuse these outputs across multiple requests. This approach further reduces redundant computation and shortens response time, which is a direct improvement to the functioning of the computing system.

The system is not limited to a specific combination of libraries or databases. In a different embodiment, the server uses another natural language processing framework instead of spaCy, a different document store instead of a document-oriented database, and a different model interface to access the generative AI model. The essential structure remains that the server converts unstructured post information into structured, indexed records, performs algorithmic ranking and filtering, employs user attribute and emotion-based adaptation of instruction information, and uses these elements to control a generative AI model to produce context-aware, resource-efficient outputs. The inclusion of these specific data structures, algorithms, and module interactions establishes a technical configuration that improves processing speed, accuracy, and system resource utilization beyond what would be achievable by manual review or by naïve, unstructured invocation of a generative model.

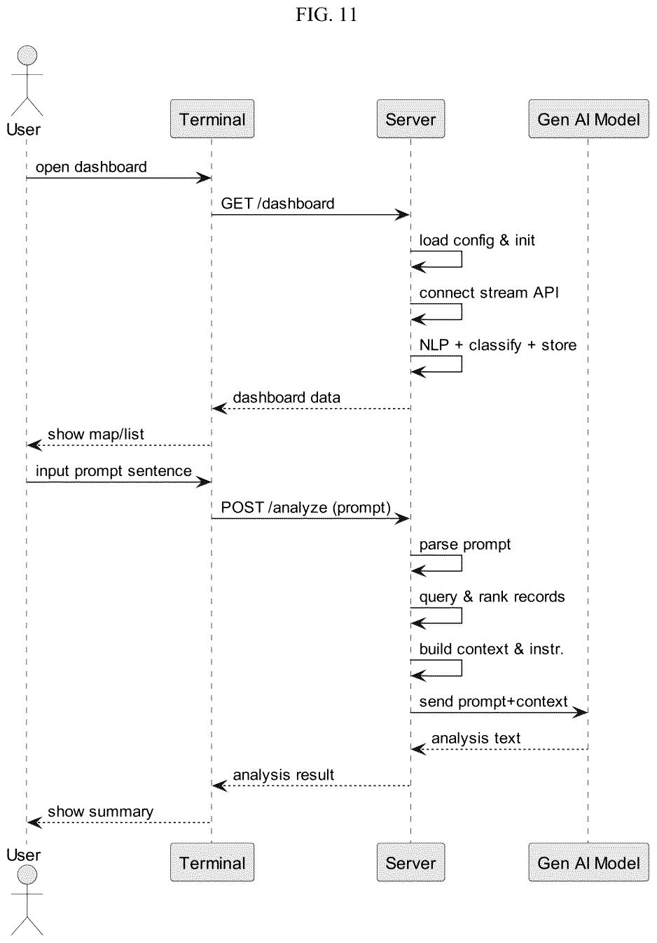

The following describes the processing flow using FIG. 11.

### Step 1

The server loads configuration information and initializes software modules.

As input, the server uses configuration files that include API credentials for the information sharing service, connection parameters for a storage device, and access parameters for a generative AI model. The server loads natural language processing libraries, a database driver, and an HTTP client library into memory. Based on this input, the server creates in-memory objects such as API client instances, database connection pools, and model interface clients, and outputs initialized components that are ready for subsequent processing.

### Step 2

The server establishes a streaming connection to the information sharing service and starts receiving post information data.

As input, the server uses the API client instance and authentication data from Step 1. The server sends an authentication request over a network interface and receives an authorization response. The server then opens a persistent HTTPS connection to a streaming endpoint and registers filters such as user identifiers or hashtags. The server parses the received byte stream into discrete JSON objects representing individual posts and outputs a continuous sequence of post information data records.

### Step 3

The server converts raw post information data into internal data records.

As input, the server receives JSON objects containing text content, timestamps, user identifiers, and optional location fields from Step 2. The server validates each JSON object, extracts necessary fields, and maps them to an internal key-value structure or object with fields such as “text,” “created_time,” “source_id,” and “raw_location.” The server performs basic normalization such as trimming whitespace and normalizing character encoding, and outputs normalized internal data records stored temporarily in main memory.

### Step 4

The server performs text preprocessing for natural language processing.

As input, the server uses the internal data records from Step 3. The server removes URLs, control characters, and unnecessary markup from the text, converts text to lowercase, and replaces common abbreviations with standardized forms. The server divides the text into sentences using a sentence boundary detection algorithm. Based on these operations, the server outputs cleaned text strings and sentence lists associated with each internal data record.

### Step 5

The server applies natural language processing to derive linguistic features.

As input, the server uses the cleaned text from Step 4. The server calls a language processing pipeline to perform tokenization, part-of-speech tagging, lemmatization, and named entity recognition. The server extracts entities such as place names, organization names, and key incident terms. The server converts the text into numeric feature vectors using methods such as TF-IDF or sentence embeddings. The server outputs enriched data records that contain both linguistic annotations and feature vectors.

### Step 6

The server classifies the disaster type and determines the affected location.

As input, the server uses the enriched data records from Step 5. The server feeds the feature vectors into a disaster-type classifier that computes probabilities for multiple disaster categories and selects the category with the highest probability above a threshold. The server resolves detected location entities into standardized geographic identifiers by matching them against a location database or mapping table. These operations constitute data calculations that map unstructured text features to discrete labels and standardized location codes. The server outputs intermediate structured information including at least a disaster type label and an affected location identifier.

### Step 7

The server determines damage content and urgency level.

As input, the server uses the linguistic annotations and feature vectors from Step 5 together with the disaster type and location from Step 6. The server applies rule-based pattern matching and dependency parsing to identify phrases indicating damage to infrastructure, transportation, or human safety. The server also applies an urgency estimation model that computes an urgency score based on sentiment indicators, lexical cues, and contextual features. The server converts the numerical urgency score into an urgency level category such as “high,” “medium,” or “low.” The server outputs a complete structured information record for each post, including disaster type, affected location, damage content descriptors, and an urgency level.

### Step 8

The server stores structured information in the storage device with indexes.

As input, the server uses the structured information records from Step 7. The server constructs database documents containing fields such as record identifier, time information, source identification information, position information, disaster type, damage content, and urgency level. The server sends insert operations to the storage device via a database driver. The server also ensures that indexes on relevant fields are created or updated. These data insertion and indexing operations transform volatile in-memory records into persistent, searchable structures. The server outputs stored records residing in the storage device and index metadata enabling efficient retrieval.

### Step 9

The terminal requests disaster information display data from the server.

As input, the terminal uses user operations such as filter selection, time range adjustment, and region choice on a graphical interface. The terminal converts these user selections into request parameters, including conditions such as “time interval,” “disaster type,” and “region identifier.” The terminal transmits an HTTP request containing these parameters to the server. The output of the terminal in this step is a structured request message that instructs the server on what subset of structured information should be retrieved and aggregated.

### Step 10:

The server retrieves and aggregates structured information for visualization.

As input, the server uses the request parameters from Step 9. The server constructs database queries using conditions on indexed fields, executes these queries on the storage device, and retrieves matching structured information records. The server performs aggregation computations such as counting incidents per region, computing time-series distributions, and grouping by disaster type and urgency level. These computational operations involve summation, grouping, and statistical calculations over the retrieved data set. The server outputs aggregated data structures such as lists of region-based incident counts, time-series vectors, and grouped incident summaries.

### Step 11

The server generates visualization-ready display data and sends it to the terminal.

As input, the server uses the aggregated data from Step 10. The server formats the data into visualization structures, such as arrays of latitude-longitude pairs with associated severity scores for map rendering, and arrays of timestamp-value pairs for charts. The server may also attach concise text summaries for each incident. The server packages these structures into a response format and transmits the response via the network interface to the terminal. The server outputs disaster information display data that is optimized for efficient rendering and minimal bandwidth usage.

### Step 12

The terminal renders dashboards and receives user prompt sentences.

As input, the terminal uses the disaster information display data from Step 11. The terminal executes drawing operations on the display device to show maps, charts, and lists. The terminal uses the coordinates and severity values to place markers on the map and uses time-series data to draw lines or bars. The user observes this information and enters a prompt sentence into a text input field, such as “Please summarize the most critical disaster reports from the last 30 minutes in the northern area of the city.” or “Based on the latest data, which areas should be prioritized for evacuation support?”. The terminal collects the prompt sentence and any additional filter settings and outputs a new analysis request containing the prompt sentence and context parameters to the server.

### Step 13

The server interprets the prompt sentence and selects relevant structured information.

As input, the server uses the prompt sentence and context parameters from Step 12. The server performs text parsing on the prompt sentence to detect expressions corresponding to time ranges, regions, or disaster types. The server combines these parsed conditions with system-defined constraints, such as a maximum number of records. The server queries the storage device using these combined conditions and retrieves a limited set of structured information records. The server then ranks the retrieved records according to urgency, recency, and diversity of locations, performing numeric scoring and sorting operations. The server outputs a ranked list of structured information records relevant to the prompt sentence.

### Step 14

The server constructs context text and instruction information for the generative AI model.

As input, the server uses the ranked structured information from Step 13 and user attribute and emotion analysis information stored in internal modules. The server converts each structured record into a template-based sentence describing time, location, disaster type, and damage content. The server concatenates a subset of these sentences into a context text, ensuring that the total token count remains within a configured limit by truncating or sampling records if necessary. The server then creates instruction information that specifies output style, level of detail, and priority criteria based on user attributes and emotional state. The server combines the context text, the original or adapted prompt sentence, and the instruction information into a model input package. The output of this step is a well-defined input structure ready to be sent to the generative AI model.

### Step 15

The server sends the model input package to the generative AI model and receives generated analysis.

As input, the server uses the model input package from Step 14. The server transmits the package to a model-serving endpoint via an HTTP request. The generative AI model processes the prompt sentence and context according to the instruction information, performing internal neural network computations. The server receives the generated output sequence from the model-serving endpoint and checks for completeness and adherence to the requested format. The server may parse the generated text into sections such as a summary, a prioritized list of areas, and recommended actions. The server outputs a structured analysis result ready for delivery to the terminal.

### Step 16

The server sends the AI-generated analysis to the terminal, and the terminal displays it to the user.

As input, the server uses the structured analysis result from Step 15. The server embeds the result into a response message, optionally combining it with references to the underlying data used for the analysis. The server transmits this response to the terminal. The terminal receives the response and renders the generated analysis in a designated area of the dashboard, for example as a text report or a bullet-point list of priority regions. The user reads the analysis and may decide to enter another prompt sentence to refine the request or to focus on a different aspect of the disaster information. The output of this step is an updated user interface on the terminal showing both the underlying data visualizations and the generative AI model's context-aware analysis.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale disaster situations, conventional computer-implemented alert systems have several technical limitations in acquiring, processing, and distributing information in real time. First, existing systems typically rely on static rule-based filters applied to incoming text streams from information sharing services. Such systems often perform simple keyword matching without robust natural language processing or adaptive classification, which leads to low precision and recall in detecting disaster-related content. As a result, processors in such systems waste computational resources on processing non-relevant posts and fail to consistently surface the most critical disaster information to end users.

Second, conventional architectures generally deliver uniform notification messages to all users, without effectively utilizing structured user attribute information such as user interests, regional context, and individual characteristics. Processors in these systems are not configured to systematically compute importance or suitability scores per user, and are not configured to dynamically adapt notification content or presentation based on those scores. This causes technical inefficiencies in bandwidth and processing, because many notifications are sent to terminal devices where they are ignored or considered irrelevant, thereby reducing the overall effectiveness of the alert infrastructure.

Third, traditional systems do not integrate generative models in a technically coordinated way with low-latency pipelines for disaster information detection. Even when advanced language models are used, they are often invoked in an ad hoc manner, without structured prompt generation that takes into account user attributes, emotional state, and contextual constraints such as message length and vocabulary level. This leads to inconsistent output quality, redundant processing, and difficulty in controlling latency and computational load, thereby degrading system responsiveness during high-traffic disaster events.

Fourth, conventional notification platforms do not take into account feedback signals from user terminal devices in a technically meaningful way. User interaction information and user-generated posts are not systematically analyzed to infer an emotional state or engagement level. Consequently, processors do not update or refine prompt generation logic or content selection logic in real time, leading to poor adaptability of the system to evolving user needs and conditions. From a computer-technology standpoint, this results in suboptimal utilization of computing resources, incomplete personalization, and non-optimized control of notification flows over constrained networks.

Accordingly, there is a need for an improved computer-implemented disaster information processing and notification system in which a processor is specifically configured to: (i) acquire and filter social information streams in a structured, machine-efficient manner; (ii) generate and use structured user attribute and emotion data to compute relevance metrics; (iii) automatically construct and update input sentences for a generative model; and (iv) control the distribution of personalized and context-aware notifications to user terminal devices via wireless networks. Such a system should improve the technical functioning of the overall computing environment by reducing unnecessary processing and network traffic, improving the relevance and clarity of notifications, and enabling more effective use of generative models under disaster-time constraints.

The specific processing by the specific processing unit 290 of the data processing device 12 in Application Example 1 is realized by the following means.

The present invention provides a server comprising a processor configured to acquire posting information from an external information processing apparatus via communication procedures of an information sharing service using identification information and authentication information, to apply language processing procedures and determination procedures to the acquired posting information to extract posting information including disaster-related information and to generate structured information representing the disaster-related information, to obtain user attribute information including interest attribute information, regional attribute information, and individual attribute information from a storage unit and to calculate an importance degree and a suitability degree of the disaster-related information based on the user attribute information in order to select target users for distribution, to generate for each selected target user an input sentence including a command sentence sequence that specifies an expression format, a detail level, and a vocabulary level of distribution content based on the structured information and the user attribute information, to input the input sentence and the structured information into a generative information processing model to cause the generative information processing model to output personalized notification information, and to transmit a notification information group including the notification information and destination device identification information as well as display control information via a wireless communication network using communication procedures of a notification distribution service to user terminal devices, and further configured to analyze user operation information and user posting information received from the user terminal devices by an emotion analysis procedure to generate emotion attribute information and to dynamically update the command sentence sequence for the generative information processing model based on the emotion attribute information and the user attribute information. This enables improved computer functionality for disaster-time notification services by providing more accurate extraction of disaster-related information, by reducing redundant processing and network traffic through user-specific importance and suitability scoring, by generating consistent and context-controlled prompts for the generative information processing model to produce concise and comprehensible notifications, and by adaptively adjusting content and expression of notifications based on real-time emotion and attribute feedback from user terminal devices.

The term “disaster situation” refers to a state in which a natural event or human-made event causes or is likely to cause significant damage or disruption, and in which rapid acquisition, processing, and distribution of information by computing systems is required.

The term “information provider” refers to an individual or organization that transmits or publishes information through an information sharing service.

The term “information sharing service” refers to a network-based service that receives, stores, and distributes posting information from multiple information providers and makes such posting information accessible via communication procedures.

The term “communication procedures of an information sharing service” refers to defined communication protocols, interfaces, and parameter formats, including programming interfaces, that enable a computing apparatus to send requests to and receive responses from the information sharing service.

The term “posting information” refers to digital content, including at least text data and optionally metadata such as creation time and source identifiers, that is generated by an information provider and stored or distributed by an information sharing service.

The term “external information processing apparatus” refers to a computing apparatus operated outside the server of the present invention, which executes processing to manage and provide access to posting information via an information sharing service.

The term “identification information” refers to information used to specify a target information provider, user account, content stream, or device, such as an identifier, handle, account ID, or device ID.

The term “authentication information” refers to information used to authorize access to the information sharing service or other computing resources, such as tokens, keys, passwords, or certificates.

The term “language processing procedures” refers to one or more algorithms executed by a processor to analyze text data, including, for example, tokenization, part-of-speech tagging, syntactic parsing, semantic analysis, or keyword extraction.

The term “determination procedures” refers to decision-making algorithms executed by a processor to determine whether posting information includes disaster-related information, including rule-based logic, statistical classifiers, or machine-learned models.

The term “disaster-related information” refers to information contained in posting information that indicates the occurrence, status, impact, or recommended response related to a disaster situation.

The term “structured information” refers to data representing disaster-related information in a machine-readable and organized format, such as a record, a field structure, or a tagged data object including attributes like type, location, time, and severity.

The term “storage unit” refers to any hardware and software combination configured to store data, including volatile or non-volatile memory, databases, or storage devices.

The term “user attribute information” refers to data describing characteristics of a user, including at least interest attribute information, regional attribute information, and individual attribute information.

The term “interest attribute information” refers to data indicating topics, categories, or types of information toward which a user has shown interest or preference.

The term “regional attribute information” refers to data specifying a geographical region associated with a user, such as residence area, frequently visited area, or target region for notifications.

The term “individual attribute information” refers to data describing personal characteristics of a user, including one or more of age group, profession, language preference, or other demographic or profile attributes.

The term “importance degree” refers to a quantitative or qualitative measure computed by a processor that indicates how critical or urgent particular disaster-related information is for a user or a group of users.

The term “suitability degree” refers to a quantitative or qualitative measure computed by a processor that indicates how relevant or appropriate particular disaster-related information is for a user or a group of users, based on user attribute information.

The term “target users for distribution” refers to one or more users selected by a processor to receive notification information, based on the importance degree and the suitability degree.

The term “notification information” refers to information generated by the processor for delivery to a user terminal device, including at least text data representing a message regarding disaster-related information.

The term “generative information processing model” refers to a computational model, such as a generative machine learning model, configured to generate text or other data outputs in response to input data including instruction sentences and structured information.

The term “input sentence” refers to a text sequence provided as input to the generative information processing model and including at least one instruction sentence and optionally additional contextual information.

The term “instruction sentence” refers to a sentence within the input sentence that explicitly or implicitly specifies how the generative information processing model should process input data, including desired output format, detail level, or vocabulary.

The term “command sentence sequence” refers to a series of one or more instruction sentences forming a structured prompt that controls behavior and output characteristics of the generative information processing model.

The term “expression format” refers to characteristics of the structure or style of text output, such as narrative form, bullet points, or alert-style phrasing.

The term “detail level” refers to the degree of granularity or amount of information included in text output, such as brief summary or extended explanation.

The term “vocabulary level” refers to a complexity level of words used in text output, such as technical language, general language, or simplified language.

The term “destination device identification information” refers to data that identifies one or more user terminal devices to which notification information is to be transmitted, such as device identifiers or registration tokens.

The term “notification information group” refers to a set of one or more notification information items and associated metadata, including destination device identification information, prepared for transmission.

The term “notification distribution service” refers to a network-based service configured to deliver notification information from a server to user terminal devices via a communication network according to predefined communication procedures.

The term “wireless communication network” refers to any network infrastructure that provides data communication without wired connections to user terminal devices, including cellular networks or wireless local area networks.

The term “user terminal device” refers to a user-operated electronic device capable of receiving data via a wireless communication network and presenting the data, such as a mobile terminal, a tablet apparatus, or a personal computing apparatus.

The term “display control information” refers to data transmitted from the server to a user terminal device, which specifies how notification information is to be presented, including layout, modality, or triggering conditions.

The term “display output” refers to the visual presentation of information on a display unit of a user terminal device.

The term “audio output” refers to the audible presentation of information via a sound output component of a user terminal device.

The term “user operation information” refers to data representing interactions performed by a user on a user terminal device, such as taps, clicks, scrolling, or selection of user interface elements related to notification information.

The term “user posting information” refers to digital content generated by a user, including text messages, reactions, or feedback, that can be acquired from a user terminal device or a network service.

The term “emotion analysis procedure” refers to one or more algorithms configured to infer an emotional state from user operation information, user posting information, or other data, including sentiment analysis, affect detection, or related computational methods.

The term “emotion attribute information” refers to data representing an inferred emotional state of a user, such as anxiety level, urgency perception, satisfaction, or other affective indicators.

The term “analysis result” refers to data generated by the processor that includes at least emotion attribute information and user attribute information, used to control subsequent processing.

The term “emotional state” refers to an affective condition of a user at a given time, such as calmness, fear, confusion, or alertness, inferred by the emotion analysis procedure.

The term “content and expression of the notification information” refers to, respectively, the substantive information contained in the notification information and the manner in which that information is worded, structured, or formatted.

In one embodiment, a server is implemented as a network-connected computer system including at least one multi-core central processing unit (CPU), a memory, a non-volatile storage device, and a network interface. The server runs an operating system, such as a general-purpose server operating system, and middleware including a web application server and a relational or non-relational database management system. The server further executes application programs written, for example, in a general-purpose programming language, and libraries for natural language processing, machine learning, and network communication.

The server accesses an information sharing service operated by an external information processing apparatus. The external apparatus exposes an application programming interface (API) that accepts HTTP or HTTPS requests and returns posting information as structured data, for example in a text-based serialization format. The server stores API credentials, including identification information and authentication information, in a secure storage area such as an encrypted configuration file or a secure key management service. The server uses these credentials to construct authenticated API requests and to obtain posting information associated with specific information providers.

The server uses an HTTP client library to send API requests and to receive responses. The server parses each response to extract posting information, including at least text data, timestamps, and identifiers of the source accounts. The server inserts the raw posting information into a persistent storage structure, such as a table in a relational database or a collection in a document database. The storage structure includes fields for a post identifier, provider identifier, posting time, language code, geographic metadata, and flags indicating processing status.

The server performs language processing procedures on the stored posting information. The server loads a tokenization and part-of-speech tagging model, for example based on a neural network sequence model or a rule-augmented statistical model, and applies the model to each text segment. The server normalizes the text by lowercasing, removing control characters, and converting full-width characters to half-width characters where applicable. The server further applies sentence segmentation to divide long texts into sentences and applies lemmatization to map inflected words to base forms. The server generates a feature vector for each post, combining token indices, part-of-speech tags, character n-gram counts, and, optionally, contextual embedding vectors computed by a transformer architecture.

The server determines whether each post includes disaster-related information by using determination procedures that combine rule-based logic and a trained classifier. The server first applies a rule engine that checks for the occurrence of domain-specific patterns, such as combinations of disaster keywords and temporal expressions, and that assigns an initial score. The server then applies a neural network classifier to the feature vector of the post. In one example, the classifier uses a transformer-based architecture with multiple self-attention layers, residual connections, and layer normalization, pre-trained on a large text corpus and fine-tuned on labeled disaster-related and non-disaster-related posts. The server computes a probability score for the disaster-related class using a softmax layer and compares the score with a threshold. The server tags posts as disaster-related when the score exceeds the threshold and updates the database record with the score and classification result.

The server generates structured information representing disaster-related information. The server defines a structured record format that includes data fields such as disaster type, estimated location, severity level, event time, and recommended action category. The server uses a sequence labeling model or a span-extraction model, for example a transformer encoder with a classification head, to identify location expressions, magnitude descriptors, and imperative phrases in the text. The server maps these extractions to standardized codes using a rule-based mapping table, such as mapping “earthquake” or “tremor” to a disaster type code, and maps place names to standardized region identifiers using a geocoding database. The server then populates the structured record and stores it in a disaster information database.

The server manages user attribute information in a user database. The server stores, for each user, interest attribute information, regional attribute information, and individual attribute information. Interest attribute information may include topic tags and historical interaction scores with different disaster types. Regional attribute information may include home region codes, frequently visited region codes, and radius values for each region. Individual attribute information may include age group, language preference, and device capability indicators. The server periodically updates the user attribute information based on usage logs, such as notification open events and in-application navigation behavior.

The server calculates, for each combination of structured disaster information and user, an importance degree and a suitability degree. For the importance degree, the server computes a score based on factors such as severity level of the disaster, distance between the event location and the user's registered regions, and recency of the event. The server uses a weighted sum or a more complex scoring function, whose parameters may be learned from past data using a gradient-based optimization method. For the suitability degree, the server calculates a similarity measure between the disaster type and the user's interest profile, and adjusts the score according to the user's language preference and device capabilities. The server stores the resulting scores in a relevance table and selects target users whose combined importance and suitability scores exceed a threshold. This score-based selection causes the server to perform fewer transmissions and fewer rendering operations for non-relevant users, thereby reducing network load and processing time.

The server uses a generative AI model as a generative information processing model to create notification information. In one embodiment, the server uses a transformer-based sequence-to-sequence model with an encoder-decoder architecture, multiple self-attention layers, and positional encoding. The model parameters are initially pre-trained on a large corpus of general text and then fine-tuned on a corpus of disaster-related alert messages. Training uses a cross-entropy loss function comparing generated tokens to reference tokens, and a gradient-based weight update algorithm such as Adam. The server stores the model weights in memory or in a model repository accessible via a model-serving process.

The server generates an input sentence for the generative AI model for each selected target user. The server constructs a command sentence sequence that includes an instruction sentence specifying the desired expression format (for example, “short emergency alert”), the detail level (“brief, within 200 characters”), and the vocabulary level (“simple language suitable for the general public”). The server appends contextual content, including fields from the structured disaster information and relevant user attributes, to the command sentence sequence. The server concatenates these elements into a single input sentence string and passes the string as input tokens to the generative AI model.

The server causes the generative AI model to output notification information by executing inference with beam search or another decoding strategy. The server constrains the maximum output length and applies penalties to repeated n-grams to avoid redundant text. The model outputs a token sequence representing the notification message. The server converts the token sequence to a text string and optionally applies post-processing such as trimming whitespace and enforcing punctuation rules. The resulting notification information is then stored in a notification queue associated with the target user and device identifiers.

In one example, the server uses the following prompt sentence as part of the input sentence to the generative AI model:
“Rewrite the following social media post into a short, clear emergency alert suitable for a push notification. Focus on safety instructions and location. Post: ‘An earthquake just occurred in the central district. Everyone, please secure your safety and stay away from damaged buildings.’”

In another example, the server uses the following prompt sentence to refine multi-lingual alerts:
“I am designing a disaster alert system that collects posts from specific publishers on a social platform, classifies them as disaster-related, and sends customized notifications via a push notification service. Suggest improved short alert messages in plain English suitable for mobile notifications, given the following structured information: disaster type, region, severity, and recommended action.”

The server interfaces with a notification distribution service to deliver the notification information to user terminal devices. The server stores, for each user terminal device, a destination device identification token, obtained when the terminal registers with the notification distribution service. The server builds a notification information group including the notification message body, an alert title, the destination device identification token, and additional metadata such as disaster type and region code. The server sends this group to the notification distribution service using a dedicated API over a secure network connection. The distribution service then pushes the message to the appropriate user terminal devices over a wireless communication network.

The terminal is implemented as a mobile terminal, such as a smartphone or tablet, or a personal computing apparatus with wireless network capability. The terminal runs an operating system providing a notification framework and an application configured to receive and display alerts. The terminal stores the registration token used as destination device identification information and periodically validates this token with the server. The terminal receives push messages from the notification distribution service and passes them to the notification framework. The terminal interprets display control information included in the messages, such as indication of whether to show an on-screen banner, to vibrate, or to play an audio alert. The terminal then generates display output on a display unit and audio output on a speaker, so that the user can perceive the notification.

The user operates the terminal by interacting with the notifications and the disaster information application. The user may tap a notification to open a detail screen, scroll through lists of alerts, or dismiss notifications. The terminal records user operation information, such as timestamps of opening and dismissing notifications, and sends this information back to the server. The user may also submit user posting information, such as feedback or status messages, which the terminal transmits to the server or to a separate service.

The server analyzes the user operation information and user posting information using an emotion analysis procedure. The server may implement a sentiment classifier using a recurrent neural network or a transformer-based text classifier that has been trained on annotated data containing labels such as “calm,” “worried,” or “confused.” The server extracts features such as polarity scores, intensity of certain affect-related words, and time intervals between user interactions. The server then computes emotion attribute information representing the user's emotional state. The server combines the emotion attribute information with the user attribute information into an analysis result, which is stored in an emotion-attribute table.

The server uses the analysis result to adapt the command sentence sequence for subsequent notifications. For example, if the emotion analysis indicates that a user is highly anxious, the server modifies the command sentence sequence to instruct the generative AI model to use more reassuring language and to add clear, step-by-step instructions. If the user appears disengaged or ignores multiple notifications, the server changes the frequency and detail level, instructing the model to generate more concise messages. By dynamically shaping the input sentence based on emotion and attribute information, the server causes the generative AI model to produce notifications that are better targeted and more likely to be effective, while simultaneously reducing unnecessary content and repeated warnings.

This configuration improves computer technology in several ways. The server reduces computational load and network traffic by filtering incoming posts through an optimized combination of rule-based logic and neural classification, so that only posts with high disaster relevance are processed further. The structured information representation allows the server to index and retrieve disaster events more efficiently, improving query performance and aggregation speed. The use of importance and suitability degrees allows the server to send fewer, more relevant notifications, which reduces bandwidth consumption and CPU usage on both the server and the terminal.

The explicit construction of command sentence sequences as inputs to the generative AI model enables deterministic control of the model's behavior, reducing variance in output length and style and thus reducing the need for additional post-processing. The model architecture and training strategy are chosen to minimize inference latency and maximize classification and generation accuracy, so that the system can respond quickly under high load in a disaster situation. The emotion analysis procedure and feedback-based prompt adaptation enable the server to converge toward more effective messaging strategies without human intervention, improving the overall responsiveness and effectiveness of the alert system beyond mere automation of human tasks.

In alternative embodiments, the server may employ different types of neural network architectures for classification and generation, such as a convolutional neural network for short-text classification or a recurrent encoder-decoder model for generation. The server may also use different optimization algorithms, loss functions, and data augmentation techniques, such as synonym replacement or back-translation, to increase robustness against noisy social media text. The structured information schema may be extended to include additional fields such as infrastructure impact, evacuation routes, or shelter availability. The user attribute information may be expanded to include device battery level or connectivity type, allowing the server to adjust notification frequency and size further to reduce power consumption and avoid congestion on constrained networks.

In another variation, the terminal may support offline caching of structured disaster information and partial notification messages, enabling the terminal to display at least minimal alerts when connectivity is intermittent. The server can send compact, pre-encoded instructions that the terminal interprets locally, thereby offloading part of the processing from the server and reducing latency in areas with weak communication infrastructure.

Through these embodiments and variations, the server, the terminal, and the user cooperate in a technical system that acquires, classifies, structures, personalizes, and delivers disaster-related information with improved computational efficiency, accuracy, and responsiveness, thereby providing a concrete technological improvement over conventional disaster information systems.

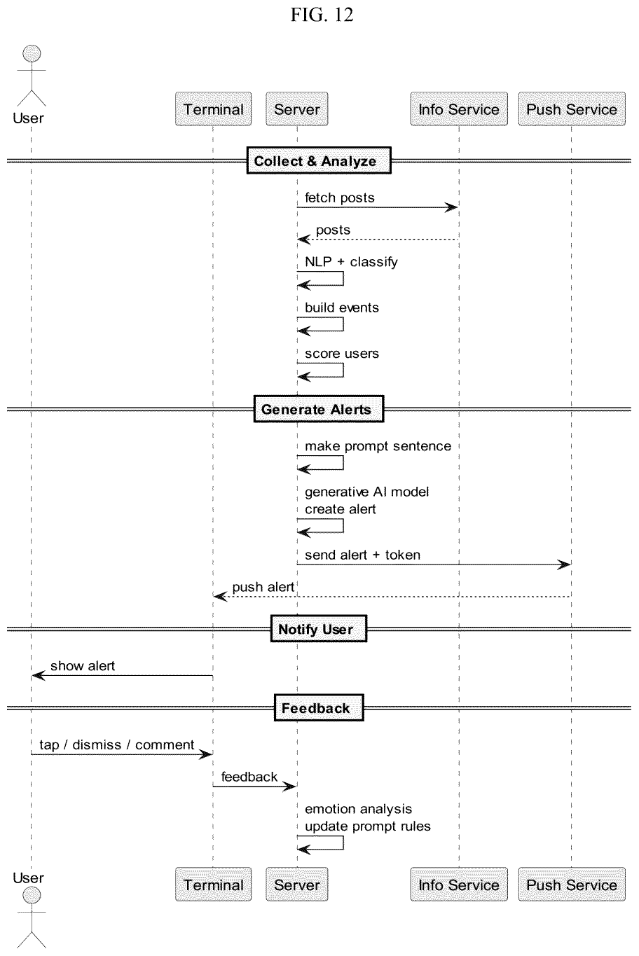

The following describes the processing flow using FIG. 12.

### Step 1

Server acquires posting information from an external information sharing service.

As input, the server uses stored identification information for information providers, authentication information for the service API, and a time range or cursor indicating which posts have not yet been processed. The server constructs API requests according to the communication procedures of the information sharing service, including query parameters such as provider identifiers and time filters, and transmits the requests via a network interface. The server receives response messages containing posting information, parses the response format, and extracts fields such as post identifiers, text content, timestamps, and provider metadata as output. The server then stores the extracted posting information in a database table or collection, marking each entry with an initial processing status.

### Step 2

Server performs language preprocessing on the acquired posting information.

As input, the server reads unprocessed posting records from the database, including at least the text content and language indicators. The server normalizes the text by converting characters to a canonical form, removing control characters, and standardizing whitespace. The server tokenizes the text into words or subword units, assigns part-of-speech tags, and performs lemmatization, using a language processing library running on the processor. The server generates feature representations for each post, such as token index sequences, character n-gram counts, and contextual embedding vectors computed by a transformer encoder. As output, the server stores the processed tokens and feature vectors in associated data fields in the database or in an in-memory data structure, and updates the processing status for each post.

### Step 3

Server classifies posts to determine disaster-related information.

As input, the server uses the feature representations and normalized text generated in Step 2. The server first applies rule-based checks to identify posts that contain predefined disaster-related patterns, such as combinations of hazard words, location expressions, and temporal expressions, and assigns an initial rule-based score. The server then inputs the feature vectors into a trained classifier model, for example a transformer-based neural network with a softmax output layer, to compute a probability that each post is disaster-related. The server combines the rule-based score and the model probability using a weighted formula to obtain a final relevance score. As output, the server flags posts whose relevance score exceeds a threshold as disaster-related, records the score and label in the database, and discards or archives non-relevant posts.

### Step 4

Server generates structured disaster information from classified posts.

As input, the server reads posts labeled as disaster-related in Step 3, including the text and classification scores. The server applies a sequence labeling or span-extraction algorithm to the text to identify key elements such as disaster type, location, severity descriptors, and recommended actions. The server uses mapping rules and a geocoding database to convert extracted text spans into standardized codes, such as disaster type codes, region identifiers, and severity levels. The server then builds a structured record for each event, including fields for event time, location code, disaster type code, severity, and recommended action category. As output, the server stores these structured records in a dedicated disaster information database and links them to the corresponding original posts.

### Step 5

Server retrieves and updates user attribute information.

As input, the server accesses user records from a user database, including interest attribute information, regional attribute information, individual attribute information, and historical interaction logs. The server may also receive new interaction logs from the terminal, such as notification open events or dismissal events, and incorporates these logs into the user profile. The server updates interest scores based on the frequency with which a user interacts with particular disaster types, adjusts regional weights according to recent location information, and refreshes individual attributes as needed. As output, the server maintains an updated user attribute data structure for each user, which includes normalized interest vectors, region priority lists, and individual attribute codes.

### Step 6

Server computes importance and suitability scores for each user-event combination.

As input, the server uses the structured disaster information from Step 4 and the updated user attribute information from Step 5. For each user and disaster event pair, the server computes an importance degree based on factors such as severity level, temporal proximity, and geographic distance between the event location and the user's registered regions. The server also computes a suitability degree based on the alignment between disaster type and user interests, language preferences, and device capabilities. The server performs these computations using numerical formulas and, optionally, regression or ranking models trained on historical performance data. As output, the server writes importance and suitability scores into a relevance table and identifies target users whose combined score exceeds a predefined threshold.

### Step 7

Server constructs command sentence sequences and input sentences for a generative AI model.

As input, the server uses the structured disaster information, the user attribute information, and the relevance scores from Step 6 for each selected target user. The server generates a command sentence sequence that includes instruction sentences specifying the expression format (for example, “short emergency alert for mobile notification”), the detail level (“brief, focus on immediate safety actions”), and the vocabulary level (“simple words suitable for the general public”). The server appends context segments describing the disaster event (type, location, severity, recommended action) and user-related constraints (preferred language, region, age group) to the command sentence sequence. The server concatenates these elements into a single input sentence that will serve as a prompt sentence for the generative AI model. As output, the server produces, for each user-event pair, a tailored input sentence ready for generation.

### Step 8

Server generates personalized notification information using the generative AI model.

As input, the server provides the input sentence from Step 7 and, optionally, additional structured fields to a generative AI model, such as a transformer-based encoder-decoder network deployed as a serving process. The server encodes the input sentence into token IDs, feeds them into the model, and performs inference using a decoding strategy such as beam search with constraints on maximum length and repetition penalties. The model computes internal attention weights and layer outputs and finally produces a sequence of output tokens representing the notification message. The server converts the token sequence into a text string, applies post-processing such as trimming or enforcing punctuation rules, and validates that the length and content comply with the specified constraints. As output, the server stores the generated notification information, including title and body text, in a notification queue associated with each target user.

### Step 9

Server prepares notification information groups and display control information.

As input, the server reads pending notification messages from the notification queue along with destination device identification information retrieved from a device registration database. The server packages, for each target device, a notification information group that includes the notification title, body text, structured metadata (disaster type, region code, severity), and the destination device identifier. The server also generates display control information specifying presentation parameters such as whether to show a high-priority banner, to trigger vibration, or to include an audible alarm. As output, the server forms complete payloads combining the notification information group and the display control information, ready for transmission through the notification distribution service.

### Step 10

Server transmits notification payloads via a notification distribution service.

As input, the server uses the payloads from Step 9 and configuration parameters for the notification distribution service, including authentication tokens and endpoint URLs. The server sends requests to the distribution service API, embedding the payloads and destination device identifiers. The server receives response codes and status information indicating success or failure of each transmission. The server logs successes, retries failed transmissions according to a retry policy, and updates the status of each notification in the database. As output, the server ensures that successfully transmitted notification payloads reach the notification distribution service, which then pushes them to the appropriate user terminal devices over a wireless communication network.

### Step 11

Terminal registers with the notification distribution service and receives notifications.

As input, the terminal uses its device identifier and application instance information to request a registration token from the notification distribution service using a client SDK. The terminal obtains the registration token and stores it persistently, and transmits the token to the server for association with the user account. Later, when the distribution service pushes a notification, the terminal receives the incoming message, which contains the notification information group and display control information. The terminal parses the message, interprets the control parameters, and generates visual and audio outputs according to the instructions. As output, the terminal displays the notification content on a screen, optionally shows an icon or banner, and may play a sound or vibration alert.

### Step 12

User interacts with notifications and provides implicit and explicit feedback.

As input, the user perceives the visual and auditory outputs presented by the terminal and the notification content generated by the server. The user may tap the notification to open a detailed information screen, scroll through related content, or dismiss the notification without opening it. The user may also input explicit feedback, such as pressing a “useful information” or “not relevant” button, or posting a status update within the application. As output, the user's actions generate user operation information (open events, dismiss events, button selections) and user posting information (feedback texts, comments), which the terminal records and prepares for transmission to the server.

### Step 13

Terminal sends user operation information and user posting information to the server.

As input, the terminal collects logged interaction events and user-generated messages associated with notifications and disaster content. The terminal packages these data into update messages including timestamps, identifiers of the corresponding notifications, and the raw or lightly processed text of user postings. The terminal transmits the update messages to the server over a secure network connection, for example when a stable connection is available or according to a batching policy to reduce network overhead. As output, the terminal provides the server with up-to-date feedback data that reflect user engagement and emotional responses.

### Step 14:

Server performs emotion analysis and updates emotion attribute information.

As input, the server receives user operation information and user posting information from the terminal, and reads corresponding user attribute information from the user database. The server uses an emotion analysis procedure, such as a sentiment classification model with a neural network architecture, to process the text of user postings and to infer polarity and intensity of emotions. The server also analyzes interaction patterns, such as frequent dismissals or rapid opening of multiple alerts, to infer levels of concern or confusion. The server converts these results into emotion attribute information, for example numerical scores representing anxiety, trust, or confusion. As output, the server updates an emotion-attribute record for each user, storing the latest emotion attribute information and linking it to the time and context of recent notifications.

### Step 15

Server adapts future command sentence sequences and notification generation based on feedback.

As input, the server uses the emotion attribute information from Step 14 together with the existing user attribute information and performance logs of previous notifications. The server updates the rules and parameters used to construct command sentence sequences, for example by adjusting the desired detail level for users who appear overwhelmed, or by changing the vocabulary level for users who appear confused. The server may also modify the thresholds for importance and suitability scores to reduce the number of low-impact notifications for disengaged users. As output, the server generates new, adapted command sentence templates and parameter settings, which are then used in subsequent executions of Step 7 and Step 8 to produce notifications that are more precisely tailored to each user's state and context, while improving computational efficiency and reducing unnecessary message traffic.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional audio distribution systems and alert systems are not well suited to handling large volumes of heterogeneous textual information in real time, especially in emergency situations. In typical architectures, a server simply aggregates posts or messages and either displays them as text or converts them to audio using fixed templates and static text-to-speech pipelines. Such systems have several technical limitations.

First, conventional systems lack an integrated mechanism for automatically extracting high-priority content and emotional context from unstructured electronic information. When a large number of posts are generated on multiple platforms, simple keyword filtering or rule-based extraction causes delays and requires extensive manual tuning, which degrades throughput and increases processing load on the server. As a result, relevant information may be missed, and the system cannot efficiently prioritize and structure information for broadcast-type audio distribution.

Second, conventional systems do not adequately adapt audio distribution to heterogeneous user attributes and dynamic feedback. In many implementations, the server distributes the same audio content to all user terminals, or only applies coarse-grained filtering based on a limited set of user attributes. There is no systematic way to integrate user profiles, context information, and feedback into a closed-loop mechanism for adjusting prompts to a generative AI model and thereby controlling the style, length, and information density of generated scripts. This inflexibility results in suboptimal personalization, increased user interaction latency, and unnecessary consumption of communication and computation resources.

Third, the integration between emotion analysis, generative AI models, and streaming distribution is typically ad hoc or absent. Existing systems that do use generative AI models do not maintain a structured feedback loop in which emotion information and explicit evaluation data are stored as learning data and used to update prompt generation rules and distribution conditions. Without such a feedback mechanism, the system cannot continuously improve its generation and scheduling logic, and the server cannot optimize its behavior in response to changes in user emotional state or situational context. This leads to technically inefficient use of processing resources and does not fully exploit the capabilities of modern text-to-speech and streaming technologies.

Accordingly, there is a need for an improved computer-implemented system in which a server processor: (i) automatically extracts important information and emotion information from electronic information collected from multiple sources, (ii) generates instruction documents (prompt sentences) for a generative AI model based on user attributes and environment information, (iii) converts generated broadcast-type scripts to streaming-ready audio data for one-way simultaneous distribution, and (iv) dynamically updates the instruction documents and distribution conditions by leveraging user feedback and accumulated learning data. Such a system would improve the overall efficiency, scalability, and adaptability of the server-side audio distribution pipeline as a computer technology.

The specific processing by the specific processing unit 290 of the data processing device 12 in Example 2 is realized by the following means.

The present invention provides a server comprising a processor configured to collect electronic information from a plurality of information sources by using a communication function of an information sharing infrastructure, analyze the collected electronic information using language processing technology and emotion analysis technology to extract important information and emotion information, and generate, based on the extracted important information and emotion information, a base document for audio distribution and distribution conditions; to generate, based on the base document and the distribution conditions, an instruction document for input to a generative information processing model while referring to user attribute information and user environment information, and to cause the generative information processing model to generate a document for broadcast-type audio distribution; to convert the document for broadcast-type audio distribution into audio information by using text-to-speech technology to convert text information into audio information, to process the converted audio information into broadcast-type audio distribution data that enables one-way simultaneous distribution to a plurality of user terminals, and to distribute the broadcast-type audio distribution data via a communication network using a streaming method; and to dynamically update contents of the instruction document, contents of the document for broadcast-type audio distribution, and a distribution time, based on the user attribute information, preference information, and evaluation information regarding distributed content, acquired from the plurality of user terminals, and further to store the emotion information and the evaluation information as learning data and update generation rules of the instruction document and the distribution conditions based on the learning data. This enables the server to implement an improved, closed-loop audio distribution pipeline in which extraction of important and emotional information, generation of prompts for a generative AI model, conversion to broadcast-type streaming audio, and adaptive optimization based on user feedback are tightly integrated, thereby improving the technical performance, scalability, and responsiveness of computer-implemented audio distribution in dynamic and emergency environments.

The term “electronic information” refers to information expressed in a digital format, including text, symbols, numerical data, and any other machine-processable content acquired or generated by a computing system.

The term “information source” refers to any hardware or software entity that provides electronic information to the server, including networked platforms, databases, sensors, or communication interfaces.

The term “information sharing infrastructure” refers to a communication environment or platform through which multiple users or systems post, exchange, or distribute electronic information via a network.

The term “posting information” refers to electronic information created and transmitted by a user or system to the information sharing infrastructure, including messages, comments, reports, or status updates.

The term “language processing technology” refers to a software-implemented technique for automatically analyzing natural language text, including tokenization, morphological analysis, syntactic analysis, semantic analysis, and extraction of structured data from unstructured text.

The term “emotion analysis technology” refers to a software-implemented technique for automatically detecting or estimating emotional states or sentiments from electronic information, including sentiment analysis, affective computing, and emotion classification algorithms.

The term “important information” refers to a subset of electronic information that is determined, by language processing technology and optionally by predefined rules or learned models, to be relevant, urgent, or high priority for distribution.

The term “emotion information” refers to data indicating an emotional state or sentiment associated with electronic information, a user, or a group of users, including categories such as positive, negative, neutral, or more fine-grained emotional labels.

The term “base document” refers to a structured text object generated from important information and emotion information, serving as an intermediate representation for subsequent processing, including generation of prompts and distribution scripts.

The term “distribution conditions” refers to control parameters used for managing distribution of audio content, including timing, target user groups, priority levels, repetition frequency, and delivery channels.

The term “user attribute information” refers to profile data associated with a user or user terminal, including demographic characteristics, regional characteristics, language preferences, and usage patterns.

The term “user environment information” refers to contextual information related to conditions under which a user receives content, including location, time zone, device type, network status, and surrounding situation.

The term “preference information” refers to data representing a user's interests, likes, dislikes, and content consumption tendencies, derived from explicit settings, behavior logs, or inferred patterns.

The term “evaluation information” refers to feedback data indicating a user's assessment of distributed content, including ratings, reactions, engagement metrics, and explicit comments.

The term “instruction document” refers to a text object that encodes instructions or a prompt sentence for input to a generative information processing model, specifying constraints, style, content requirements, or other generation conditions.

The term “prompt sentence” refers to a specific form of instruction document comprising one or more natural language sentences that direct a generative information processing model to produce desired output content.

The term “generative information processing model” refers to a machine-implemented model, such as a generative AI model or large language model, configured to generate text or other content based on an input instruction document and optional context data.

The term “document for broadcast-type audio distribution” refers to text content generated by a generative information processing model that is formatted and structured for conversion into audio suitable for one-way, simultaneous distribution to multiple receivers.

The term “text information” refers to information represented as a sequence of characters or tokens in a human-readable or machine-readable natural language format.

The term “audio information” refers to data representing sound signals, including digital audio samples encoded in a file or stream format suitable for playback by an audio output device.

The term “text-to-speech technology” refers to a software-implemented technique that converts text information into synthesized speech audio signals.

The term “broadcast-type audio distribution data” refers to audio data packaged or encoded in a format that allows one-way simultaneous delivery of identical audio content to a plurality of user terminals.

The term “communication network” refers to an infrastructure that enables transmission of electronic information between devices, including wired networks, wireless networks, public networks, and private networks.

The term “streaming method” refers to a data transmission technique in which audio information is delivered in a continuous flow of segments or packets, allowing playback to begin before the entire content is received.

The term “user terminal” refers to an electronic device operated by or on behalf of a user to receive or present content, including computing devices, mobile devices, and dedicated playback devices.

The term “learning data” refers to stored data sets comprising emotion information, evaluation information, and optionally other contextual information, used to update or train rules or models for content generation and distribution.

The term “generation rules” refers to parameters, templates, or logical conditions used by the server to construct instruction documents for the generative information processing model, including rules for style, length, content selection, and tone.

The term “distribution time” refers to a temporal parameter specifying when audio content is to be made available for distribution or playback, including start time, end time, or scheduling intervals.

The term “closed-loop audio distribution pipeline” refers to a sequence of interconnected processing stages in which collected data, generated content, and user feedback are cyclically utilized to refine and improve subsequent content generation and distribution operations.

In one embodiment, the server includes at least one processor, a main memory, a non-volatile storage device, a network interface, and an audio interface coupled via a system bus. The server executes an operating system such as a general-purpose server operating system, and executes application programs implementing language processing, emotion analysis, generative AI prompting, text-to-speech conversion, and streaming distribution. The server stores program modules and data structures in the non-volatile storage device and loads them into the main memory during execution.

The server receives electronic information from multiple information sources through the network interface. The information sources include network-accessible platforms, databases, and sensor gateways that provide postings, reports, and status messages during normal conditions and emergency situations. The server stores the received postings in a data store using a structured data model. In one embodiment, the server represents each posting as a record including fields such as a posting identifier, a source identifier, a timestamp, a text body, a location tag, and a user identifier, and stores such records in a relational database or a key-value store.

The server applies language processing technology to the stored postings. The server loads a natural language processing module that performs tokenization, sentence segmentation, morphological analysis, part-of-speech tagging, and dependency parsing on the text body field. The server represents the text as a sequence of token objects, each including a term, a part-of-speech label, a position index, and dependency relations. The server uses these token objects to compute features such as term frequencies, n-grams, and named entity labels. The server executes a classification algorithm, such as a support vector machine or a neural classifier, on these features to determine whether each posting contains important information, such as alerts, location-specific hazards, or resource needs.

The server applies emotion analysis technology to the same or related postings. The server generates emotion feature vectors by aggregating token-level attributes, lexicon-based scores, and contextual embeddings obtained from a neural encoder. The server, for example, uses a recurrent neural network, a convolutional neural network, or a transformer-based encoder trained on emotion-labeled corpora. The server computes, for each posting, a probability distribution over emotion categories such as fear, anxiety, urgency, calm, and neutrality. The server stores the resulting emotion information in association with each posting identifier in the data store.

The server generates a base document for audio distribution by aggregating important information and emotion information. The server retrieves postings classified as important within a defined time window and within relevant geographic or topical constraints. The server orders these postings using a priority score computed from factors such as an importance score from the classifier, an urgency component derived from the emotion probabilities, and a recency measure derived from timestamps. The server converts the ordered postings into a structured text object that includes a header section, a body section containing summarized items, and an optional tail section containing follow-up instructions. The server stores this base document in the data store as a text record linked to distribution conditions.

The server determines distribution conditions for the base document. The server retrieves user attribute information, user environment information, and known network conditions from the database. The server computes a distribution schedule that includes a distribution start time and repetition parameters, based on time zones, historical listening patterns, and current network load. The server also determines target user groups identified by region, language preference, and device capabilities. The server stores these distribution conditions as a structured configuration object linked to the base document.

The server generates an instruction document, functioning as a prompt sentence, for a generative AI model. The server constructs the instruction document by combining: (i) a system-level directive specifying output style and constraints, (ii) a summary of the base document, (iii) selected user attribute information such as region and persona, and (iv) emotion and evaluation statistics. The server uses templates that define sections of the instruction document and inserts variable values into placeholders. For example, the server may generate an instruction document in plain text such as:
“Write a concise, broadcast-style audio script for an emergency update based on the following data.
Location: metropolitan coastal region.
Situation: severe storm warning, road closures, power outages in some districts.
Target listeners: adults commuting to work, high stress level detected from recent posts.

### Requirements

Length: under 45 seconds when spoken.
Tone: calm but clear, with emphasis on safety instructions.
Include a brief summary of the situation and two concrete actions listeners should take.

Data summary: [here the server inserts summarized important information].”

The server transmits the instruction document over the network interface to a generative AI model hosted either locally or on a remote computing system. In one embodiment, the generative AI model is implemented as a multi-layer neural network with an encoder-decoder architecture or a transformer-based architecture pre-trained on large text corpora and optionally fine-tuned on domain-specific scripts. The server passes the instruction document to the model input layer after tokenization and embedding, and the model generates a sequence of output tokens representing a document for broadcast-type audio distribution. The server receives this generated document and stores it as a text field in the data store.

The server uses text-to-speech technology to convert the document for broadcast-type audio distribution into audio information. The server selects a voice configuration based on language, gender preference, and emotional tone. The server calls a text-to-speech engine, which may be a neural speech synthesizer implementing an encoder-decoder model with attention or a similar neural architecture. The server provides the document text and configuration parameters, and the text-to-speech engine outputs digital audio samples representing synthesized speech. The server encodes the audio samples into a compressed format, such as a widely used audio compression format, and stores the resulting audio file in an object store or file system.

The server prepares the audio for broadcast-type distribution by segmenting and packaging the audio into streaming-compatible data structures. The server invokes a media processing module that divides the audio file into multiple segments of a fixed length and generates a playlist manifest describing the segment order. The server organizes the segments and the manifest in a hierarchical directory structure accessible through the network interface. The server configures a streaming server module that responds to client requests by serving the manifest and the corresponding segments, enabling one-way, simultaneous distribution to multiple user terminals.

The terminal receives streaming configuration information from the server. The terminal stores device parameters such as available bandwidth, display size, and audio capabilities. The terminal requests the manifest from the streaming server module and retrieves audio segments sequentially. The terminal decodes the audio and plays it through loudspeakers or headphones. The terminal also captures user interaction data, such as playback duration, skip events, and volume adjustments, and sends evaluation information back to the server.

The user interacts with the system through the terminal. The user may explicitly provide feedback, such as a rating or a brief textual comment regarding the clarity, length, or usefulness of the audio content. The user may also modify profile settings, such as preferred topics, preferred listening times, and acceptable alert levels. The terminal transmits this information as structured data records to the server, which stores them as evaluation information and preference information in the user database.

The server aggregates evaluation information and emotion information as learning data. The server constructs feature vectors that summarize, for each distribution session, attributes such as the content style parameters, length of the script, emotion distribution in source postings, user persona, and objective engagement metrics. The server stores these feature vectors with labels derived from evaluation information. The server applies a training algorithm, such as stochastic gradient descent or an adaptive optimization method, to update parameters of a rule model that maps context features to prompt template selections and parameter values. In one embodiment, the server implements this rule model as a separate neural network or as a decision tree ensemble that outputs weights for different prompt templates and parameters such as target length and tone.

The server updates generation rules for instruction documents using the learned parameters. The server adjusts, for example, thresholds for summarization, weightings for emotion cues, and constraints on script length. When generating a new instruction document, the server refers to the updated rules to select a prompt template and parameterize it. As a result, the server dynamically adapts the content and style of prompt sentences to improve user comprehension and satisfaction while controlling computational and communication resources.

The server improves computer technology in several ways. By using structured data models for postings, emotion information, and evaluation information, the server reduces search and retrieval complexity when generating base documents and distribution conditions. By using priority scoring that combines importance, emotion, and recency, the server reduces latency in selecting high-priority content under high data volume conditions, thereby improving processing speed. By generating instruction documents that explicitly encode constraints on length and style, and by feeding user feedback back into prompt generation rules, the server controls the behavior of the generative AI model in a way that reduces unnecessary verbosity and redundant content, thereby reducing audio length and network transmission volume. By segmenting audio into streaming assets and scheduling distribution according to distribution conditions, the server reduces peak bandwidth usage and balances network load, improving communication efficiency.

The server employs non-conventional processing steps that differ from simple automation of human tasks. A human operator may read posts, summarize them, and speak them aloud, but the server introduces a specific combination of machine-readable data structures, neural emotion analysis, generative prompting, and adaptive rule learning that enables fine-grained, automated optimization beyond human capacity. The server uses internal machine-learning-based models with clearly defined architectures and error minimization procedures, and the server continuously adjusts its operations based on quantitative feedback. This closed-loop control of content generation and distribution constitutes an improvement in the functioning of the computer system itself, as it leads to lower processing overhead per unit of useful information delivered and reduces error rates in prioritization and personalization.

In another embodiment, the server deploys the generative AI model locally and uses a multi-head attention-based transformer network with a defined number of layers, attention heads, and embedding dimensions. The server stores model weights in optimized binary formats and uses hardware acceleration such as vector instruction sets or dedicated acceleration hardware. The server applies data augmentation techniques when training emotion analysis and rule models, for example by injecting noise into textual inputs or synthesizing paraphrases, to improve robustness. The server adjusts learning rates and regularization parameters to avoid overfitting and to maintain stable performance in the presence of evolving language usage during emergencies.

In a further embodiment, the server uses different prompt templates and distribution strategies for non-emergency content, such as weather updates or general news. The server modifies the instruction document to request a friendly, radio-style script with less urgency and longer explanatory segments. For example, the server may generate a prompt sentence such as:
“Write a short, friendly radio-style weather forecast based on the following data.
Location: urban area.
Weather: clear, high 25 degrees, low 18 degrees.
Target listeners: general audience, commuting in the morning.

### Requirements

Length: under 30 seconds when spoken.
Tone: casual and easy to understand.
Include one practical suggestion for the day.”

By applying the same closed-loop optimization mechanism, the server gradually adjusts style and length to match user preferences while maintaining efficient use of network and processing resources.

In yet another embodiment, the terminal operates as a low-power device with limited processing capabilities. The server offloads most computationally intensive tasks, such as emotion analysis, generative text generation, and audio synthesis, to centralized hardware. The terminal performs lightweight operations such as caching, basic decoding, and UI rendering. This architecture allows the system to scale to a large number of user terminals, while centralized optimization at the server reduces duplication of heavy computation and results in improved system-wide efficiency.

By combining these embodiments, the system provides a concrete, technically grounded implementation that enables a server, terminals, and users to cooperate in generating, optimizing, and distributing broadcast-type audio content in a way that enhances processing speed, accuracy, communication efficiency, and adaptivity beyond conventional text aggregation and static text-to-speech systems.

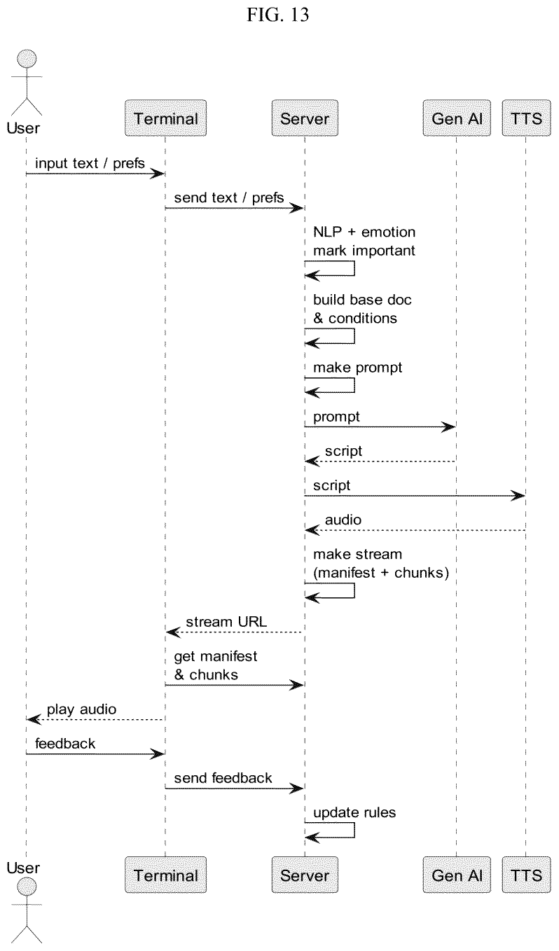

The following describes the processing flow using FIG. 13.

### Step 1

The server receives electronic information from multiple information sources.

The server uses a network interface to accept incoming messages, posts, or reports transmitted over a communication network. The server treats each incoming item as input data containing at least a text field, a timestamp field, and a source identifier field. The server parses protocol headers (for example, HTTP headers), extracts the message body, and normalizes character encoding. The server then stores each item as a record in a database, adding an internal posting identifier and indexing the text field for later search. The input of this step is raw network messages from the information sources, and the output of this step is a set of normalized posting records stored in the database.

### Step 2

The server analyzes the textual content of the postings using language processing technology.

The server retrieves a batch of posting records from the database as input, each including a text body. The server loads a natural language processing module and applies tokenization, sentence segmentation, and part-of-speech tagging to each text body. The server converts each text body into a sequence of token objects represented in memory, where each token object includes a term string, a position index, and a part-of-speech label. The server computes derived features, such as term frequency, n-gram frequency, and named entity labels, and stores these features in an intermediate feature table. The input of this step is stored posting records, and the output is structured linguistic feature data associated with each posting identifier.

### Step 3

The server determines important information by applying a classification algorithm to the linguistic features.

The server takes the feature vectors of each posting as input and feeds them into an importance classifier implemented as a machine-learning model. The server may use, for example, a neural network or a support vector machine that outputs an importance score and a binary importance label. The server applies a threshold to the importance score to classify postings as important or not important. The server writes the importance label and priority score back to the database for each posting. The input of this step is linguistic feature data per posting, and the output is importance labels and priority scores stored as additional fields in the posting records.

### Step 4

The server extracts emotion information from the postings using emotion analysis technology.

The server retrieves the same or filtered set of posting records and uses their text bodies as input. The server encodes each text body into an emotion feature vector by using a neural encoder model, such as a recurrent neural network or a transformer encoder, which transforms sequences of tokens into dense numeric vectors. The server then passes these vectors through an emotion classifier layer that outputs a probability distribution over predefined emotion categories. The server selects the dominant emotion category and stores both the probability distribution and the selected category as emotion information for each posting. The input of this step is textual content of the postings, and the output is emotion feature vectors and emotion labels recorded in the database.

### Step 5

The server constructs a base document for audio distribution by aggregating important postings and their emotion information.

The server queries the database for postings marked as important within a given time window and, optionally, within specified regions or topics. The server uses importance scores, emotion labels, and timestamps as input values to compute a global priority score for each posting using a weighted formula that combines importance, urgency, and recency. The server sorts postings by the global priority score and selects the top entries. The server then generates a structured text base document by concatenating summaries of the selected postings into sections (for example, overview, detailed items, and follow-up). The server stores this base document as a record with an associated identifier. The input of this step is a set of labeled postings with importance and emotion data, and the output is a structured base document ready for further processing.

### Step 6

The server determines distribution conditions based on user attribute information and environment information.

The server retrieves user profiles and device capabilities from the user database as input, including region, time zone, preferred language, and typical listening times. The server also reads network condition metrics, such as average throughput and current load, from monitoring data. The server computes, for each target user group, a distribution schedule with start time, repetition interval, and maximum duration, and determines grouping rules based on region and language. The server stores these distribution conditions in a distribution configuration table linked to the base document identifier. The input of this step is user attribute information and environment information, and the output is structured distribution conditions associated with the base document.

### Step 7

The server generates an instruction document (prompt sentence) for a generative AI model based on the base document and distribution conditions.

The server takes as input the base document, the distribution conditions, and aggregated user attribute information for a target group. The server selects a prompt template from a library of templates according to content type and urgency level. The server fills the template's placeholders with values derived from the base document (for example, summarized situation description), user persona information, and any relevant emotion statistics. The server concatenates these elements into a coherent instruction document in natural language. As a concrete operation, the server may generate a prompt sentence such as:
“Write a concise, broadcast-style emergency update based on the following data.
Location: coastal metropolitan area.
Situation: heavy rainfall, flooding in low-lying districts, transportation disruptions.
Target listeners: commuters and residents, high anxiety level detected from recent posts.

### Requirements

Length: under 45 seconds when spoken.
Tone: calm and authoritative.
Include a brief summary and two clear safety instructions.”

The server stores this instruction document and prepares it as input for the generative AI model. The input of this step is the base document and distribution parameters, and the output is a fully formed instruction document.

### Step 8

The server generates a document for broadcast-type audio distribution by invoking the generative AI model with the instruction document.

The server sends the instruction document over a network interface or internal API to the generative AI model. The server tokenizes the instruction document and converts tokens into numerical embeddings as input vectors to the generative model, which may be a transformer-based neural network with multiple attention layers. The server receives an output sequence of tokens from the model, decodes them into text, and obtains a fully written script for broadcast-type audio distribution. The server stores this generated script as a text record associated with the corresponding base document and user group. The input of this step is the instruction document, and the output is a generated broadcast script in text form.

### Step 9

The server converts the generated broadcast script into audio information using text-to-speech technology.

The server provides the broadcast script as input to a text-to-speech engine along with parameters such as language code, voice profile, and speaking rate. The server passes the script to the TTS engine, which splits the text into phonetic units, predicts prosody, and synthesizes a waveform using an acoustic model. The server receives raw audio samples from the TTS engine and encodes them into a compressed audio format. The server writes the resulting audio file to storage and records metadata such as file path, duration, and sample rate. The input of this step is the generated broadcast script text, and the output is a compressed audio file representing synthesized speech.

### Step 10

The server prepares streaming-compatible audio distribution data from the synthesized audio.

The server uses the stored audio file as input and invokes a media processing component that segments the audio into fixed-length chunks. The server generates a playlist manifest describing the sequence and timing of the chunks. The server places the chunks and manifest in a designated directory or object storage bucket accessible via the streaming server. The server registers the manifest URL as the broadcast endpoint for the corresponding user group and distribution schedule. The input of this step is the audio file, and the output is a set of segmented audio files and a manifest that together form broadcast-type audio distribution data.

### Step 11

The terminal acquires and plays the broadcast-type audio distribution data.

The terminal receives a streaming URL from the server as input, either via an API response or a preconfigured channel list. The terminal opens the URL using a media player module, requests the playlist manifest, and then sequentially requests the audio segments listed in the manifest. The terminal buffers incoming segments in memory, decodes the compressed audio, and outputs the sound through speakers or headphones. The terminal concurrently records playback metrics such as session start time, session end time, and any user-initiated skips. The input of this step is the streaming URL and associated manifest, and the output is audio playback to the user and playback metrics stored locally for later upload.

### Step 12

The user provides evaluation information and preference updates through the terminal.

The user listens to the audio content and then, using on-screen controls, inputs a rating, selects feedback options (for example, “too long,” “very helpful”), or enters a short text comment. The user may also modify preference settings, such as preferred topic categories or quiet hours. The terminal packages this information into a structured feedback message and transmits it to the server. The input of this step is the user's explicit and implicit feedback actions, and the output is a feedback message containing evaluation information and updated preference information sent to the server.

### Step 13

The server aggregates evaluation information and emotion information to update generation rules.

The server receives feedback messages from multiple terminals as input and combines them with stored emotion information and engagement metrics for corresponding distributions. The server constructs training samples, each including context features (for example, script length, emotion distribution, user persona) and target values derived from evaluation information (for example, satisfaction score). The server uses these samples to adjust parameters of a rule model that controls prompt template selection and parameter values. The server updates thresholds, weightings, and template parameters in its rule storage. The input of this step is aggregated feedback and emotion data, and the output is an updated set of generation rules and prompt configuration parameters stored in the server.

### Step 14

The server applies the updated generation rules to subsequent instruction documents and distributions.

The server reads the updated rule parameters as input when it generates new base documents and instruction documents. The server uses the new thresholds to decide how much detail to include, uses updated weightings for emotion cues to adjust the tone, and uses revised length constraints to reduce unnecessary verbosity. The server thereby modifies future instruction documents and distribution conditions according to the learned rules. The input of this step is the updated rule set, and the output is modified instruction documents and distribution schedules that result in more precise, efficient, and personalized broadcast-type audio distributions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information delivery systems that acquire user-generated content from network-based information sharing services and push it to user terminals typically treat such content as static text or static audio items. These systems generally apply fixed filtering rules, non-adaptive ranking logic, and simple text-to-speech transformation without deeply modeling user context such as dynamic emotional state, temporal behavior patterns, or long-term interaction history. As a result, the underlying computer-implemented pipelines are not configured to adaptively restructure data flows or processing parameters in response to fine-grained user feedback, and therefore fail to efficiently utilize computing, storage, and network resources for delivering context-appropriate content.

In many existing architectures, a server collects large volumes of posting information, performs coarse natural language processing, and then broadcasts identical or nearly identical audio messages to many users. Such architectures lack a mechanism to integrate (i) per-user emotion estimation from heterogeneous signals, (ii) behavior-driven feedback loops, and (iii) prompt control for a generative artificial intelligence model into a unified processing pipeline. Consequently, servers must either over-deliver content, causing unnecessary load and user fatigue, or under-deliver critical and supportive content, reducing the effectiveness of the system. These limitations manifest as suboptimal scheduling of processing tasks, inefficient construction of input data for generative models, and non-optimized configuration of text-to-speech pipelines, thereby reducing the technical performance of the computer system as a whole.

Furthermore, conventional systems that do employ generative artificial intelligence models often rely on static or manually crafted prompts that are not generated or updated in a structured, programmatic manner based on live behavioral data and emotion scores. Without automated construction and refinement of prompt sentences in response to measurable interaction metrics, the generative model is not used efficiently, leading to excessive or unnecessary calls, redundant generated text, and increased latency and computation cost at the server. Existing systems also typically do not manage transmission queues on a per-user basis with dynamic frequency control driven by emotion transition indices. This absence of algorithmic control over the timing and type of audio encoding information degrades network utilization and reduces the responsiveness of the system to rapidly changing conditions such as disasters.

Accordingly, there is a need for a computer-implemented system that (i) programmatically generates and updates prompt sentences for a generative artificial intelligence model based on user attribute information, interest information, and behavior history information, (ii) uses emotion estimation processing to compute emotion state information and emotion intensity information that directly influence both content selection and transmission frequency at the server, and (iii) manages per-user transmission queues and feedback-driven model updates so that the entire server-side processing pipeline—from acquisition of posting information, through natural language processing and generative model invocation, to conversion into audio encoding information—is adaptively controlled. By improving how the server constructs context, selects candidate delivery information, and schedules audio transmission based on machine-interpretable signals, the computer system can achieve a technically improved mode of operation with reduced unnecessary processing, more efficient network bandwidth usage, and lower latency for delivering relevant and supportive content, particularly in disaster situations.

The specific processing by the specific processing unit 290 of the data processing device 12 in Application Example 2 is realized by the following means.

The present invention provides a server comprising a processor configured to acquire, in response to occurrence of a disaster, a plurality of user posting information items from an information sharing service by using a communication interface of the information sharing service; to store the acquired user posting information items as character information and to extract summary information including event information and positional information by using a character information processing technique while assigning emotion state information by emotion estimation processing; to read, from a storage device, attribute information, interest information, and behavior history information relating to a user and to generate a candidate delivery information set by associating the summary information and the emotion state information with the read information; to construct, based on context information including the candidate delivery information set and the information relating to the user, a prompt sentence as an instruction sentence to be input to a generative information processing model, to input the prompt sentence to the generative information processing model, and to cause the generative information processing model to generate delivery character information including explanatory information and encouragement information for audio delivery; to input the delivery character information to a voice generation processing technique to convert the delivery character information into audio encoding information, to register the audio encoding information in a transmission queue associated with a delivery target user, and to sequentially transmit the registered audio encoding information via a wireless communication path; and to receive, from a terminal device, reproduction results of the transmitted audio encoding information and evaluation information and operation information from the user, to store the evaluation information and the operation information as the behavior history information in the storage device, and to update the candidate delivery information set and conditions for constructing the prompt sentence based on the behavior history information. This enables the server to dynamically and automatically control data acquisition, natural language processing, generative model invocation, and audio transmission frequency according to quantified user emotion and behavior, thereby improving utilization of computing and network resources, reducing unnecessary processing and latency, and enhancing the technical performance of the computer system in delivering context-appropriate information.

The term “disaster” refers to a situation in which an abnormal event, including a natural event or a human-made event, causes significant disruption to normal living conditions or infrastructure such that rapid information acquisition and delivery are required.

The term “user posting information” refers to information items that a user provides to an information sharing service, including at least text content and optionally metadata such as a posting time, a posting location, and an identifier of the user.

The term “information sharing service” refers to a network-based service that enables multiple users to transmit, store, and browse user posting information via a communication network.

The term “communication interface of the information sharing service” refers to an application programming interface or another programmatic interface that allows a computer system to send a request to and receive data from the information sharing service.

The term “character information” refers to information represented as a sequence of characters, including letters, numbers, symbols, and control characters, that is suitable for processing by character string processing circuitry or software.

The term “character information processing technique” refers to a processing technique executed by hardware or software to analyze or transform character information, including at least tokenization, normalization, and extraction of structured information from unstructured text.

The term “summary information” refers to information obtained by processing detailed character information so as to extract a reduced representation that retains at least event information and positional information that are determined to be relatively important for subsequent processing.

The term “event information” refers to information indicating that a particular event or occurrence has taken place, including at least a type of event, such as an opening of a facility or a change in a hazard level, and optionally a time and a location of the event.

The term “positional information” refers to information indicative of a geographic location, including at least a coordinate, a region name, or a facility name that can be mapped to a geographic region.

The term “emotion estimation processing” refers to processing that analyzes character information or other user-related information to compute one or more values indicative of an emotion state of a user, such as fear, sadness, or calmness, and an intensity of the emotion state.

The term “emotion state information” refers to information representing a result of emotion estimation processing, including at least an emotion category and optionally one or more numeric scores representing intensity or confidence.

The term “storage device” refers to a hardware component or combination of hardware components, such as a memory device or a nonvolatile storage device, that is configured to store and provide information including attribute information, interest information, and behavior history information.

The term “attribute information” refers to information that characterizes a user in terms of relatively stable properties, including at least age group, geographic region, and one or more profile-related properties.

The term “interest information” refers to information representing topics or categories in which a user has shown or is predicted to have interest, such as technology, travel, or safety-related topics.

The term “behavior history information” refers to information representing past behavior of a user in relation to delivered content or system interactions, including at least records of content presented, user operations, and evaluation information.

The term “candidate delivery information set” refers to a collection of one or more information items that are selected as candidates for delivery to a user, each information item being generated or selected by associating summary information and emotion state information with user-related information.

The term “context information” refers to composite information used to control processing by the generative information processing model, the composite information including at least the candidate delivery information set and user-related information such as attribute information, interest information, and behavior history information.

The term “prompt sentence” refers to a sequence of characters formatted as an instruction or request that is supplied as input to a generative information processing model to cause the generative information processing model to generate output information in a desired manner.

The term “generative information processing model” refers to an information processing model implemented by hardware and software that is configured to generate new character information in response to input information, where the model has been trained using data and is capable of natural language generation.

The term “delivery character information” refers to character information generated by the generative information processing model for delivery to a user, the character information including at least explanatory information and encouragement information.

The term “explanatory information” refers to character information that describes content, context, or meaning of events or conditions in a form that is understandable by the user, such as explanations of disaster-related conditions or safety measures.

The term “encouragement information” refers to character information that is intended to provide psychological support or comfort to the user, such as messages expressing empathy, reassurance, or positive guidance.

The term “voice generation processing technique” refers to a processing technique executed by hardware or software to convert character information into audio encoding information representing synthetic speech.

The term “audio encoding information” refers to data representing audio content encoded in a format suitable for transmission and reproduction, such as a compressed or uncompressed digital audio format.

The term “transmission queue” refers to a data structure maintained by the server-side system that stores one or more items of audio encoding information associated with a delivery target user and that specifies an order or timing for transmitting the items.

The term “delivery target user” refers to a user that is designated as a recipient of at least one item of audio encoding information stored in the transmission queue.

The term “wireless communication path” refers to a physical and logical communication connection that employs at least one wireless communication technology to transmit information between the server and a terminal device.

The term “terminal device” refers to an information processing device operated by or accessible to a user, such as a portable communication device or a stationary computing device, that is configured to receive audio encoding information and to output audio or other content to the user.

The term “reproduction results” refers to information indicating how audio encoding information was reproduced at a terminal device, including at least whether the audio was started, paused, skipped, or played to completion.

The term “evaluation information” refers to information that explicitly or implicitly indicates a user's evaluation of delivered content, including at least positive reactions, negative reactions, and neutral reactions.

The term “operation information” refers to information representing user operations performed via a terminal device in relation to delivered content or system interfaces, including at least selection operations, control operations, and input operations.

The term “time-of-day information” refers to information indicative of a time or period within a day at which a particular processing operation or user interaction occurs.

The term “transition index of the emotion state” refers to a value or set of values calculated based on emotion state information, time-of-day information, and behavior history information, representing how a user's emotion state changes over time.

The term “transmission frequency” refers to a measure of how often audio encoding information items are transmitted from the server to a terminal device over a specified time period.

The term “free-description information” refers to character information directly input by a user in an unconstrained textual form, such as a comment or message entered into a text field.

The term “emotion intensity information” refers to information that numerically or categorically indicates a magnitude or strength of an emotion state associated with a user at a particular time.

The term “emotional support information” refers to information that is generated or selected in order to mitigate negative emotions, reinforce positive emotions, or otherwise support the emotional condition of a user.

In an embodiment, a server cooperates with one or more terminal devices operated by users to provide adaptive audio delivery of information derived from network-based posting information. The server is implemented on general-purpose computing hardware such as a rack-mounted computer or a virtual machine in a data center. The server comprises at least one central processing unit (CPU), a volatile memory, a nonvolatile storage device such as a solid-state drive, a network interface controller, and an operating system such as a general-purpose server operating system. The terminal is implemented as a mobile information processing device such as a smartphone or tablet, or as a fixed information processing device such as a desktop computer, comprising a CPU, a memory, a wireless communication interface, a microphone, a speaker, and a display unit.

The server executes program modules written in a programming language such as Python, Java, or C++. The server uses a web framework, for example a Python-based web framework, to expose application programming interfaces (APIs) over a communication network such as the Internet. The server uses a database management system such as a relational database or a document-oriented database to store attribute information, interest information, behavior history information, and posting information. The server further uses an external text-to-speech service, an external natural language analysis service, and an external generative AI service, each accessible via network APIs. The server may also use local libraries for natural language processing, such as a tokenizer, a part-of-speech tagger, or a named entity recognizer.

The server acquires user posting information from an information sharing service by calling a communication interface such as a REST API provided by the information sharing service. The server sends an authenticated request including at least a query for posts associated with disaster-related keywords, user identifiers, or geographic regions. The information sharing service returns posting information in a structured data format such as JSON. The server parses each JSON object and maps fields such as text content, timestamp, geographic tag, and user identifier into internal data structures. The server stores these structures as records in the database, using tables or collections with defined schemas, for example a table with columns for post_id, text_body, timestamp, latitude, longitude, and source_user_id.

The server processes the text_body field of each stored post using a character information processing technique. The server first normalizes the text by converting all characters to a canonical form, removing control characters, and standardizing whitespace. The server then performs language-specific tokenization to segment the text into tokens. The server optionally applies a part-of-speech tagger and a named entity recognizer to identify event information such as “shelter opened” or “bridge closed” and positional information such as place names and facility names. The server condenses the original text into summary information by selecting key sentences or by constructing a shorter sentence that preserves at least the identified event information and positional information. This summarization may be performed using a heuristic scoring algorithm that weights tokens based on term frequency, named entity presence, and position in the text.

The server applies emotion estimation processing to the same text. In one embodiment, the server uses an external natural language analysis service that returns sentiment polarity scores and emotion category probabilities. The server sends the normalized text as input and receives, as output, values representing sentiment scores and probabilities for categories such as fear, sadness, anger, and joy. In another embodiment, the server executes a locally hosted neural network that implements a text-based emotion classifier. The neural network may be a multi-layer architecture comprising an embedding layer, one or more recurrent or transformer layers, and a final dense layer with a softmax output. The server converts tokens into embedding vectors, feeds them into the neural network, and obtains emotion category scores. The server records the results as emotion state information, which includes both a dominant emotion label and an emotion intensity value computed, for example, as the maximum probability across the categories.

The server stores the summary information and the emotion state information in association with the original post record. The server thereby maintains, for each post, a compact representation usable for downstream content selection. By performing this preprocessing at the server side, the system reduces the volume of data that must be processed subsequently by more complex modules such as the generative AI model and the text-to-speech engine, which leads to improved processing throughput and reduced latency in disaster scenarios.

The server stores attribute information, interest information, and behavior history information relating to each user in the database. Attribute information may include age group, region, and device type. Interest information may include topic tags such as “earthquake safety,” “technology,” or “travel,” derived from explicit user selections on the terminal or inferred from past behavior. Behavior history information includes records of content delivered to the user, playback completion flags, timestamps of accesses, and evaluation information such as likes and skips.

The server generates a candidate delivery information set for each user by associating the pre-processed summary information and emotion state information with the stored user-related information. The server uses indexed queries to select posts whose geographic range overlaps the user's region, whose event types match registered interest topics, and whose emotion state information satisfies predefined thresholds. The server then constructs an ordered collection structure, such as a list or priority queue, where each element comprises references to summary information, event types, positional information, and emotion state information. The server may assign an initial priority score to each element using a scoring function that combines relevance to the current disaster, topical interest alignment, and emotion category.

The server constructs a prompt sentence to be supplied to a generative information processing model. The generative information processing model may be an external generative AI service based on a large-scale neural network architecture such as a transformer network with multiple attention layers and a large number of parameters. The server does not merely pass through raw text; instead, the server programmatically assembles a structured instruction that explains the current context and specifies constraints on the desired output. For example, the server may construct a prompt sentence such as:
“You are preparing audio broadcast content for a user. The user is interested in earthquake safety and lives in the coastal region. The user is currently anxious according to recent posts. Using the following summarized posts, generate a concise and clear 3-paragraph script that (1) explains the latest shelter information and evacuation routes and (2) includes short encouraging messages to reduce anxiety. Summaries: [list of summary information].”

In another example, the server may construct a prompt sentence such as:
“Based on the user's profile and past viewing history, generate several short, relaxing stories and gentle messages that are suitable for late-night listening and that support emotional stability.”

The server includes, within the prompt sentence, conditions such as maximum length, target tone, priority of factual accuracy, and inclusion of encouragement information. The server then sends the prompt sentence and supporting context to the generative information processing model and receives, as output, delivery character information containing paragraphs of explanatory information and encouragement information.

The server applies validation and post-processing rules to the delivery character information. The server may detect and remove prohibited content based on pattern matching or classification, may enforce upper limits on length by truncation or summarization, and may reformat the text into sections suitable for audio segmentation. The server then stores the delivery character information in association with the corresponding user and context.

The server converts the delivery character information into audio encoding information using a voice generation processing technique. The server calls a text-to-speech service and specifies parameters such as language code, voice style, speaking rate, and volume normalization. The server segments the text into suitable chunks to optimize latency and streaming performance and converts each chunk to an audio encoding format such as a compressed digital audio stream. The server stores references to the resulting audio files in the database and registers each file in a transmission queue associated with the target user. The transmission queue may be implemented as a time-ordered queue or priority queue that supports insertion with scheduling metadata and retrieval in transmission order.

The terminal periodically communicates with the server to obtain information about pending audio content in the transmission queue. The terminal sends authentication information and user identifiers and receives metadata about upcoming audio encoding information items. The terminal requests and receives the audio data over a wireless communication path such as a mobile data network or a local wireless network. The terminal decodes the audio encoding information and outputs the audio through the speaker or earphones. The terminal may display the corresponding text summary or a title on the display unit.

The user listens to the audio and performs operations such as play, pause, skip, and replay, and may provide explicit evaluation information by pressing buttons such as “like” or “dislike” or by entering free-description information in a text field. The terminal records these operations as operation information and evaluation information, including timestamps and identifiers of the content items. The terminal sends this feedback data to the server via the network API.

The server updates the behavior history information using the received evaluation information and operation information. The server stores, for each delivered item, a record of whether the user completed playback, skipped early, or provided positive or negative evaluation. The server also stores any free-description information as additional character information for emotion analysis. The server uses this data to compute behavior-based features such as completion rate, preference for certain content types, and sensitivity to content length.

The server calculates a transition index of the emotion state of the user. The server uses time-of-day information and a sequence of past emotion state information values extracted from user posts and comments and from delivered content reactions. The server may implement this calculation using a temporal model such as an exponentially weighted moving average or a simple recurrent neural network that receives as input a time series of emotion categories and intensity values. The output of this model is a value that indicates the trend of the user's emotion, for example, whether negative emotion is increasing or decreasing.

The server changes both the type of information to be included in the delivery character information and the transmission frequency of audio encoding information registered in the transmission queue based on the transition index of the emotion state. For example, when the transition index indicates sustained high anxiety, the server increases the weight of encouragement information in the prompt sentence and increases the maximum number of items allowed in the transmission queue per hour, while limiting redundant factual updates. When the transition index indicates stable or improving emotion, the server reduces the frequency of transmissions and allocates more capacity to neutral informational content.

The server calculates emotion intensity information by inputting operation information and free-description information from the terminal device into the emotion estimation processing module. For example, the server may treat frequent skips of content with negative sentiment as an indicator of high sensitivity, and may detect explicit phrases indicating distress within free-description information. The server combines these indicators with existing emotion state information to compute a refined emotion intensity value. The server then dynamically generates new prompt sentences that specify that the generative information processing model should preferentially generate emotional support information, such as: “According to recent behavior, the user is very anxious and frequently skips long disaster reports. Generate a short and highly empathetic message that acknowledges the user's feelings and provides concise, reassuring guidance without excessive detail.”

The server improves technical performance of the computer system by incorporating these feedback signals directly into internal control logic for prompt construction, content selection, and queue management. Because the server generates prompt sentences in a structured and adaptive way based on measurable behavioral and emotional features, the generative information processing model is less likely to produce irrelevant or excessively long responses, thereby reducing computation time at the server and transmission overhead to the terminal. In addition, by pre-filtering and summarizing posting information before invoking the generative model, the server reduces the size of input sequences and accelerates inference, which is particularly important in disaster conditions where latency is critical.

The server may implement the generative information processing model as an external neural network service whose internal architecture comprises multiple transformer blocks, each with multi-head self-attention, feedforward layers, and normalization layers. The model may be trained beforehand using a large corpus of text. The server does not retrain the model at runtime but influences the model's behavior through the design of prompt sentences and selection of supporting context. In another embodiment, the server maintains a smaller, local generative model tuned for domain-specific language, and updates the model by fine-tuning on anonymized user interaction logs. The server can configure learning parameters such as learning rate and batch size, can calculate a loss function such as cross-entropy between predicted tokens and ground-truth tokens, and can update weights by gradient descent. Such training improves the match between generated content and the target domain, thus improving the accuracy and fluency of output.

The server implements module-level separation between (i) acquisition and preprocessing of posting information, (ii) emotion estimation and behavior modeling, (iii) prompt construction and generative model invocation, and (iv) text-to-speech conversion and queue-based transmission control. Data flows between modules through defined data structures, such as normalized post records, summary objects, context objects, prompt objects, and queue entries. Each data structure includes explicit fields that allow the server to apply rule-based and learned transformations. This modular and structured design improves maintainability and allows targeted optimization of individual modules, such as caching intermediate emotion scores or batching prompt sentences for more efficient generative model calls.

The server achieves a technical improvement over conventional systems in several ways. First, the server reduces processing load and latency by performing early-stage summarization and emotion estimation, thereby limiting the volume of data passed to computationally intensive modules. Second, the server reduces network traffic by selectively transmitting only audio encoding information that has been prioritized based on user relevance and emotional need, rather than broadcasting identical content to all users. Third, the server improves accuracy of relevance and emotional alignment by using behavior history information and emotion intensity information to dynamically adjust decision thresholds and prompt structures. Fourth, the server improves system stability in disaster scenarios by controlling queue lengths and transmission frequencies based on technical metrics such as emotion transition indices and device connectivity status.

Alternative embodiments are possible. The server may use different machine learning algorithms for recommendation and emotion modeling, such as gradient boosted trees or other neural network architectures. The server may implement local caching of frequently used audio segments at the terminal to further reduce transmission load. The server may support multiple languages by storing language-specific templates for prompt sentences and by selecting appropriate voice models for text-to-speech. The server may also adjust processing parameters based on device capabilities, such as reducing bitrate or chunk size for low-bandwidth networks.

The terminal may include additional sensing capabilities for capturing user signals, such as accelerometer data or ambient sound levels, which the server can incorporate as additional features into behavior history information. The user may configure privacy settings on the terminal to control which types of data are sent to the server, and the server may adapt its processing pipeline based on available signals.

By structuring the system in this way, the server, terminal, and user cooperate to implement a computer-implemented method that is not merely an automation of human reading and speaking, but a technical mechanism for adaptive control of text processing, generative modeling, and audio delivery. The result is a system that improves the efficiency, scalability, and responsiveness of network-based information delivery, particularly under constrained conditions such as disasters, and that demonstrates a specific improvement in the functioning of the computer system itself.

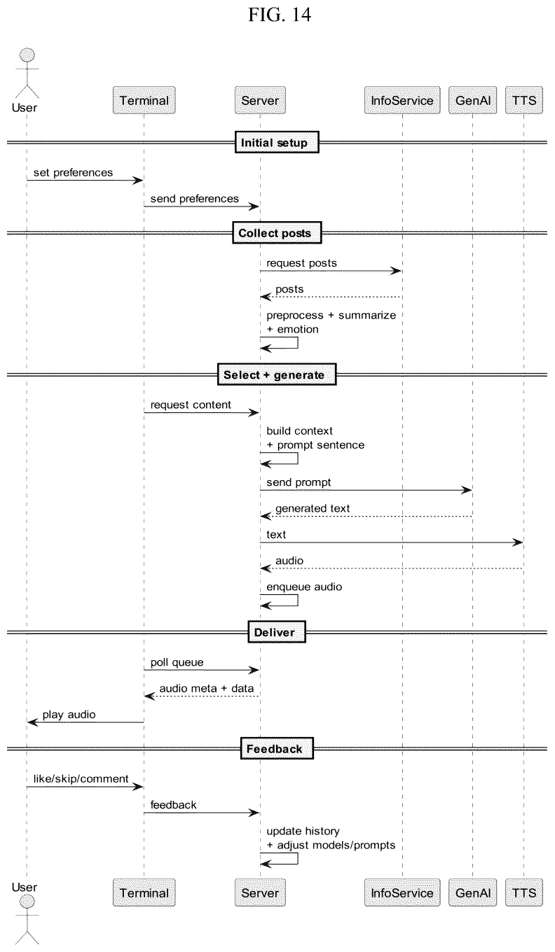

The following describes the processing flow using FIG. 14.

### Step 1

Server acquires posting information from an information sharing service.

Server receives, as input, a disaster condition trigger (for example, a flag set by an external monitoring process) and one or more query parameters such as region identifiers, disaster-related keywords, and user identifiers. Server constructs API requests using these parameters and sends the requests to the communication interface of the information sharing service. Server receives, as output, structured posting information items in a format such as JSON. Server parses the JSON, extracts fields including text content, timestamp, user ID, and location tags, and writes normalized records into a database table or collection.

### Step 2

Server performs text normalization and linguistic preprocessing.

Server receives, as input, raw text content and metadata from the database records created in Step 1. Server converts characters to a canonical encoding, removes control characters and extraneous whitespace, and performs language-specific tokenization to split text into tokens. Server may apply a part-of-speech tagger and a named entity recognizer to each token sequence. Server generates, as output, preprocessed text sequences and annotated structures (for example, token lists and entity lists) and stores them as additional fields in the same records or in linked tables.

### Step 3

Server extracts summary information including event and positional information.

Server receives, as input, the annotated text structures from Step 2. Server identifies candidate sentences that contain event-related verbs (for example, “open,” “close,” “flood”) and named entities representing locations or facilities. Server calculates a relevance score for each sentence using a weighting function over term frequency, presence of named entities, and sentence position. Server selects one or more sentences with scores above a threshold or constructs a shorter sentence by combining extracted predicate-argument pairs. Server outputs summary information objects that include event types, positional information, and the condensed text, and attaches these objects to the corresponding post records in the database.

### Step 4

Server estimates emotion state information from text.

Server receives, as input, normalized text content and optional free-description information associated with each post. Server calls an emotion estimation module, which may be implemented as a neural network classifier or an external sentiment/emotion API. Server converts tokens into numerical vectors (for example, using word or subword embeddings), feeds the vectors into the classifier, and obtains a probability distribution over emotion categories and a sentiment polarity score. Server determines, as output, a dominant emotion label and an emotion intensity value for each post and stores this emotion state information in the database linked to the corresponding post.

### Step 5

Server compiles user-related information from stored data.

Server receives, as input, a user identifier for each target user and accesses database tables storing attribute information, interest information, and behavior history information. Server reads fields such as age group, region, registered topics, past delivered content identifiers, completion flags, likes, skips, and timestamps. Server aggregates these values into structured feature vectors by counting topic frequencies, calculating average completion rates, and encoding attribute categories. Server outputs user feature records that summarize each user's attributes, interests, and behavior history, and temporarily stores them in memory or a cache.

### Step 6

Server selects and ranks candidate content for each user.

Server receives, as input, the user feature records from Step 5 and the summary information and emotion state information from Steps 3 and 4. Server applies filtering rules to choose posts whose region overlaps the user's region, whose topics match user interests, and whose disaster relevance exceeds a threshold. Server then applies a scoring function or a machine learning model that takes as input user features and content features (such as topic, recency, emotion category, and source) and outputs a relevance score for each post relative to the user. Server builds, as output, a candidate delivery information set for each user, represented as an ordered list or priority queue of content items with associated scores.

### Step 7

Server computes emotion transition indices for users.

Server receives, as input, historical emotion state information from previous posts and reactions, time-of-day information, and current emotion state information from Step 4. Server constructs a time series for each user, composed of emotion intensity values and timestamps. Server applies a temporal algorithm such as an exponentially weighted moving average or a recurrent model to this time series to compute a transition index reflecting whether negative or positive emotion is increasing or decreasing over recent time windows. Server outputs, for each user, an emotion transition index and stores it in the behavior history or in a separate table for scheduling control.

### Step 8

Server constructs a prompt sentence for a generative AI model.

Server receives, as input, the candidate delivery information set from Step 6, the user feature record from Step 5, and the emotion transition index from Step 7. Server selects a subset of candidate items based on score thresholds and emotion needs (for example, prioritizing highly relevant safety information when emotion intensity is high). Server assembles a context structure containing user attributes, interest topics, current and recent emotions, and selected summaries. Server then programmatically generates a prompt sentence by inserting values from this context into a predefined template. For example, server may output a prompt sentence such as: “You are preparing audio broadcast content for a user. The user lives in the coastal region, is interested in earthquake safety, and is currently anxious according to recent posts and reactions. Using the following summarized posts, generate a concise, factual, and empathetic 3-paragraph script that explains shelter locations and evacuation routes and includes brief encouraging messages. Summaries: [list of summaries].”

Server outputs the completed prompt sentence and stores an association between the prompt and the user.

### Step 9

Server invokes the generative AI model and generates delivery character information.

Server receives, as input, the prompt sentence from Step 8 and any selected supporting text such as summaries or context labels. Server sends this input to a generative AI model via a network API, specifying parameters such as maximum token length, sampling temperature, and safety options. The generative AI model, implemented as a neural network (for example, a transformer with multiple attention layers), processes the input and returns generated text. Server receives, as output, delivery character information comprising explanatory paragraphs and encouragement messages. Server may post-process this text by removing disallowed content, trimming length, and splitting into segments suitable for audio, and then stores the processed delivery character information linked to the user and context.

### Step 10

Server converts delivery character information into audio encoding information.

Server receives, as input, the processed delivery character information from Step 9. Server segments the text into manageable lengths and sends each segment to a text-to-speech service with parameters such as language, voice profile, and speaking rate. The text-to-speech service returns audio data in an encoded format such as a compressed digital audio stream. Server collects these audio segments, assigns identifiers, and stores file references or binary blobs in a storage system. Server outputs audio encoding information entries that include file references, sequence order, and metadata, and enqueues these entries into a transmission queue associated with the corresponding user.

### Step 11

Server manages transmission queues and determines transmission frequency.

Server receives, as input, the audio encoding information entries from Step 10, the emotion transition index from Step 7, and optionally network status indicators. Server evaluates the emotion transition index to determine whether the user requires more frequent supportive content or more conservative delivery. Server applies queue management rules that adjust insertion priorities and allowed queue length per time unit. For example, when emotion intensity and negative trend are high, server permits more frequent insertion and earlier transmission times; when emotion is stable, server spaces out transmissions. Server updates the transmission queue data structure, setting scheduled transmission times for each audio encoding information item, and outputs a sorted queue ready for consumption by transmission logic.

### Step 12

Terminal retrieves and plays audio content.

Terminal receives, as input, notifications or polling responses from the server indicating pending audio encoding information items in the transmission queue. Terminal sends requests containing user identifiers and authentication tokens, and receives, as output, metadata and URLs or binary streams for the audio encoding information. Terminal uses its network interface to download or stream the audio data, decodes the encoded audio, and uses the audio output hardware to play the content to the user. Terminal may also display on-screen titles or brief textual summaries received from the server as auxiliary information.

### Step 13

User listens to the audio and provides reactions.

User receives, as input, the audio content played by the terminal and any associated text on the display. User operates the terminal by pressing play, pause, skip, like, or dislike buttons, or by entering free-text comments. User thereby generates operation information (for example, skip events, replay events) and evaluation information (for example, likes, dislikes, textual feedback). The terminal records these operations with timestamps and content identifiers and prepares them as feedback data for the server.

### Step 14

Terminal sends feedback data to the server.

Terminal receives, as input, the user's operation information and evaluation information from Step 13. Terminal packages this data into structured feedback messages containing user ID, content ID, action type, timestamp, and any free-description text. Terminal transmits these messages to the server over the network interface using a feedback API. Terminal receives, as output, acknowledgments from the server confirming successful storage of the feedback.

### Step 15

Server updates behavior history and adjusts models and prompt construction.

Server receives, as input, the feedback messages from Step 14. Server writes the evaluation information and operation information into behavior history tables, updating counts and recent activity logs for each user and for each content item. Server recomputes user-level behavior features such as completion rate, topic-specific like rate, and sensitivity to content length. Server feeds the updated features into behavior models to refine parameter estimates or cluster memberships. Server also adjusts internal parameters for prompt sentence templates, for example by shortening target lengths for users who frequently skip long messages, or by increasing the proportion of encouragement content for users who react positively to supportive messages. Server outputs updated user feature records, revised behavior model parameters, and updated template selection rules, which are then used as new inputs in subsequent executions of Steps 6 through 9.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

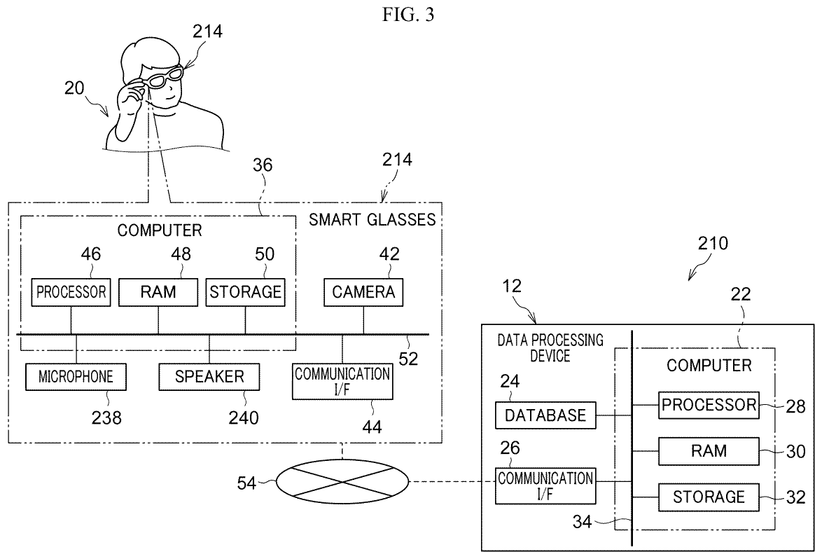

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

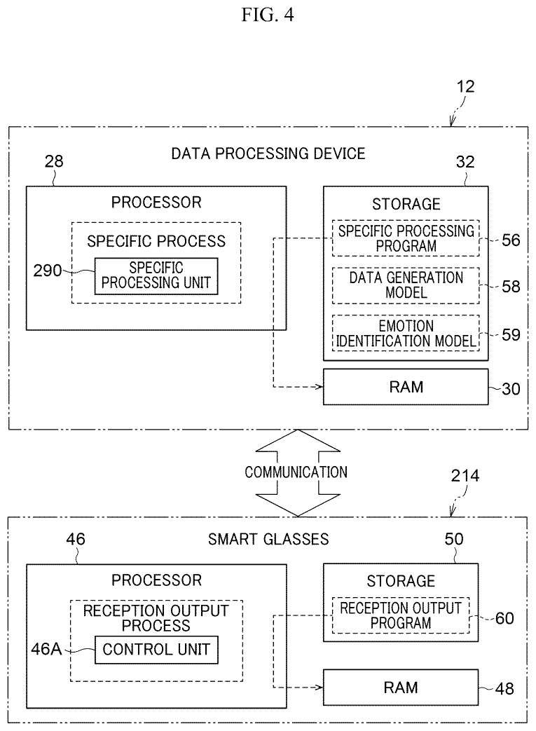

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https: //openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

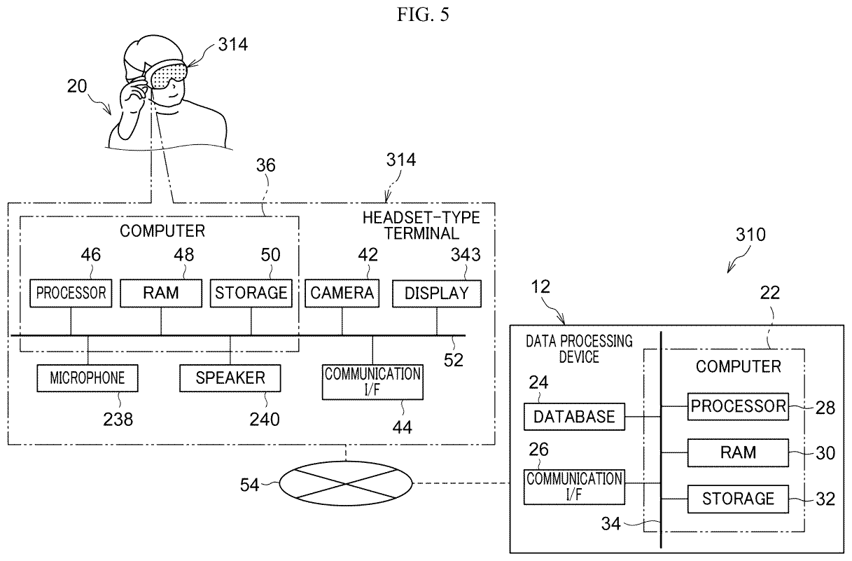

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

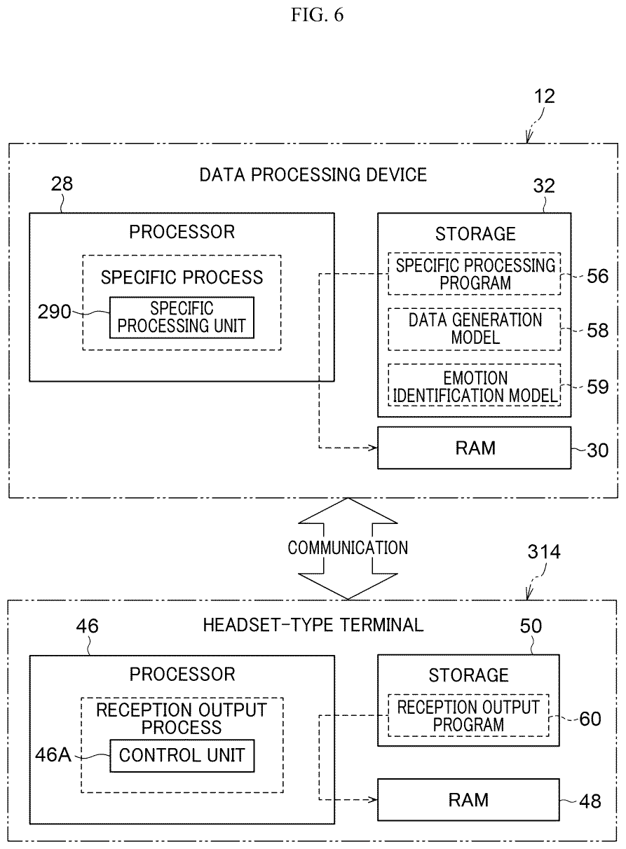

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

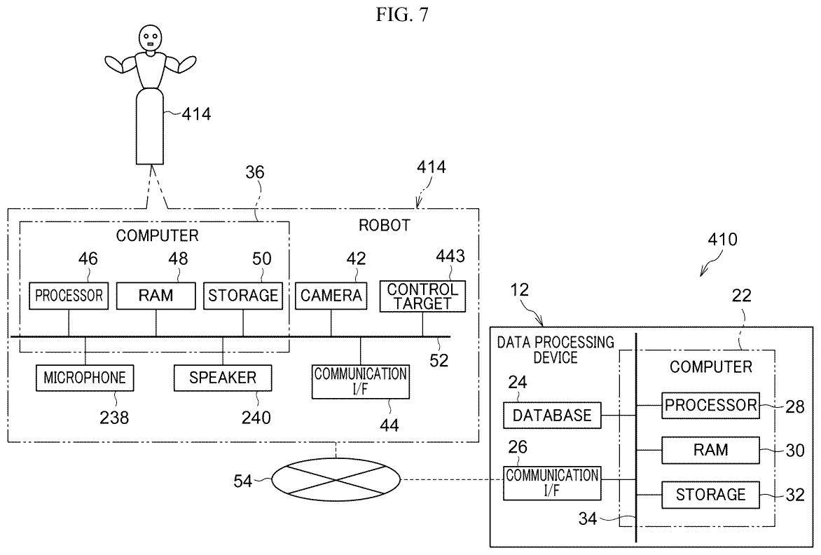

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

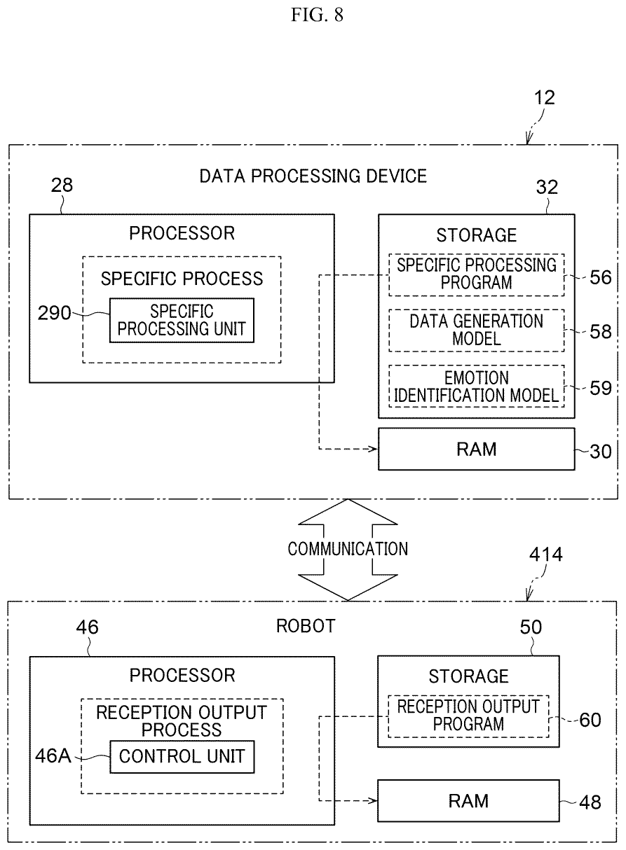

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

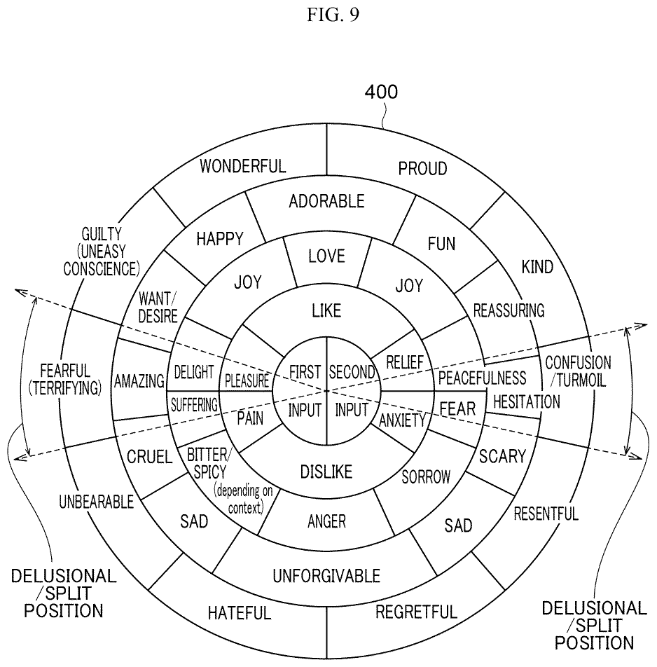

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

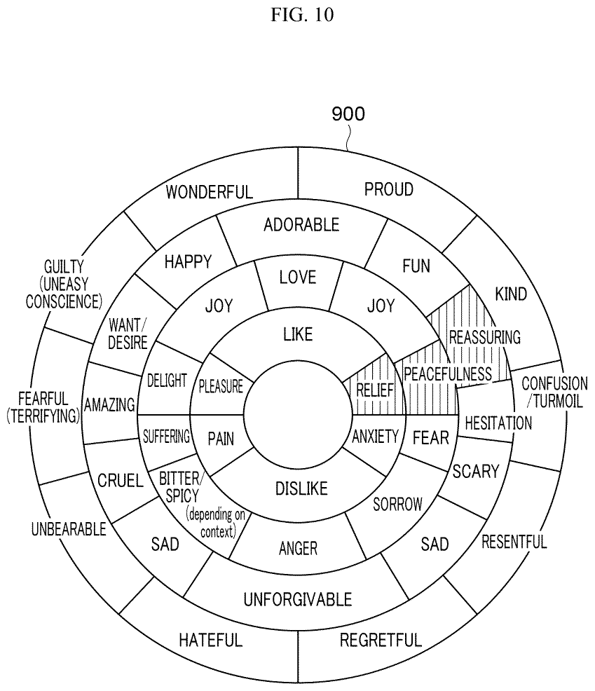

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, in the event of a disaster, post information associated with a specific user from an information sharing service by continuously receiving post information data through a public application programming interface via a communication function of at least one information source,
execute, on a computing device, natural language processing including morphological analysis, phrase segmentation, named entity extraction, sentiment estimation, and importance estimation on text information included in the post information data to extract structured information indicating a disaster type, an affected location, a damage content, and an urgency level, and to select important information based on a predetermined importance determination condition,
store the extracted structured information and the selected important information in association with time information, identification information, and position information by performing input/output control on at least one storage device including a document-oriented storage device or a relational storage device, and make the structured information retrievable in response to a search instruction,
perform, on the stored structured information, aggregation processing, classification processing, and visualization data generation processing in accordance with a time range, a region condition, and a disaster type condition, and transmit disaster information display data including list information, statistical information, and geographic information to a user terminal through a display interface, and
generate instruction information to be input to a generative machine learning model based on the stored structured information and a prompt sentence including an analysis request sentence received from a user, cause the generative machine learning model to execute additional analysis including summarization, prioritization, and proposal of a support policy regarding the structured information, and output a response information including a generation result of the generative machine learning model to be delivered to the user terminal.

### (Supplementary 2)

The system according to supplementary 1,
wherein the processor is configured to
refer to a user attribute information storage unit including attribute information, behavior history information, and location information associated with the user, and generate the instruction information for the generative machine learning model by adjusting an analysis target condition and an output format condition in the prompt sentence in accordance with a field of interest, a living area, and a behavioral characteristic of the user so as to optimize content and granularity of the additional analysis result output by the generative machine learning model.

### (Supplementary 3)

The system according to supplementary 1,
wherein the processor is configured to
execute emotion analysis processing including emotion determination processing and stress estimation processing based on transmission information and operation history of the user, and generate the instruction information for the generative machine learning model by changing, in accordance with an emotional state index obtained by the emotion analysis processing, an urgency level, a detail level, and an explanation style of expressions included in the prompt sentence so as to instruct adjustment of delivery content to the generative machine learning model.

### Application Example 1

### (Supplementary 1)

A system comprising a processor,
wherein the processor is configured to
acquire posting information in a disaster situation by obtaining, from an external information processing apparatus, the posting information of an information provider on an information sharing service using communication procedures of the information sharing service and using identification information and authentication information,
extract posting information including disaster-related information from the acquired posting information by applying language processing procedures and determination procedures, and
generate structured information representing the disaster-related information, obtain user attribute information including interest attribute information, regional attribute information, and individual attribute information from a storage unit, associate the structured information with the user attribute information, and calculate an importance degree and a suitability degree of the disaster-related information based on the user attribute information to select target users for distribution,
generate, for each selected target user, notification information by summarizing or rephrasing the disaster-related information, by generating an input sentence including an instruction sentence for a generative information processing model, and by inputting the input sentence and the disaster-related information into the generative information processing model to cause the generative information processing model to output the notification information, transmit a notification information group including the notification information and destination device identification information to user terminal devices via a wireless communication network by using communication procedures of a notification distribution service, and
transmit display control information including instruction information for presenting the notification information as display output or audio output on the user terminal devices.

### (Supplementary 2)

The system according to supplementary 1,
wherein the processor is configured to generate, as the input sentence to be input to the
generative information processing model, a command sentence sequence including an instruction sentence that specifies an expression format, a detail level, and a vocabulary level of distribution content based on the disaster-related information, the interest attribute information, the regional attribute information, and the individual attribute information, and
to operate the generative information processing model to generate different notification information for each user according to the command sentence sequence.

### (Supplementary 3)

The system according to supplementary 1,
wherein the processor is configured to analyze user operation information and user posting information acquired from the user terminal devices by using an emotion analysis procedure to extract emotion attribute information, to generate an analysis result including the emotion attribute information and the user attribute information, and to dynamically change the command sentence sequence to be input to the generative information processing model based on the analysis result so as to operate the generative information processing model to adjust content and expression of the notification information in accordance with an emotional state of a user.

### Example 2

### (Supplementary 1)

A system comprising a processor,
wherein the processor is configured to
collect electronic information from a plurality of information sources during an emergency situation by using a communication function of an information sharing infrastructure to acquire posting information, and analyze the acquired posting information by using language processing technology and emotion analysis technology to extract important information and emotion information, and generate, on the basis of the extracted important information and emotion information, a base document for audio distribution and distribution conditions,
generate, on the basis of the base document and the distribution conditions, an instruction document for input to a generative information processing model while referring to user attribute information and user environment information, and cause the generative information processing model to generate a document for broadcast-type audio distribution,
convert the document for broadcast-type audio distribution into audio information by using text-to-speech technology to convert text information into audio information, process the converted audio information into broadcast-type audio distribution data that enables one-way simultaneous distribution to a plurality of user terminals, and distribute the broadcast-type audio distribution data via a communication network using a streaming method, and
update, dynamically, contents of the instruction document and the document for broadcast-type audio distribution and a distribution time, on the basis of the user attribute information, preference information, and evaluation information regarding distributed content, acquired from the plurality of user terminals.

### (Supplementary 2)

### The System According to Supplementary 1,

wherein the processor is configured to
change contents of the instruction document for input to the generative information processing model, on the basis of user interests, regional characteristics, user persona information, and the evaluation information, thereby automatically adjusting an expression style, an amount of information, a length, and a tone of the document for broadcast-type audio distribution.

### (Supplementary 3)

The system according to supplementary 1,
wherein the processor is configured to
store the emotion information extracted by the emotion analysis technology and the evaluation information regarding the distributed content as learning data, and sequentially update generation rules of the instruction document for input to the generative information processing model and the distribution conditions, on the basis of the stored learning data, thereby frequently optimizing the audio distribution in accordance with an emotional state and a change in situation.

### Application Example 2

### (Supplementary 1)

A system comprising a processor,
wherein the processor is configured to
acquire, in response to occurrence of a disaster, a plurality of user posting information items from an information sharing service by using a communication interface of the information sharing service,
store the acquired user posting information items as character information, extract summary information including event information and positional information having relatively high importance by using a character information processing technique, and assign emotion state information to the summary information by performing emotion estimation processing,
read, from a storage device that stores attribute information, interest information, and behavior history information relating to a user, information corresponding to the user, and generate a candidate delivery information set by associating the summary information and the emotion state information with the read information,
construct, based on context information including the candidate delivery information set and the information relating to the user, a prompt sentence that is an instruction sentence to be input to a generative information processing model, input the prompt sentence to the generative information processing model, and cause the generative information processing model to generate delivery character information including explanatory information and encouragement information for audio delivery,
input the delivery character information to a voice generation processing technique to convert the delivery character information into audio encoding information, register the audio encoding information in a transmission queue associated with a delivery target user, and sequentially transmit the registered audio encoding information via a wireless communication path, and
receive, from a terminal device, reproduction results of the transmitted audio encoding information and evaluation information and operation information from the user, store the evaluation information and the operation information as the behavior history information relating to the user in the storage device, and update the candidate delivery information set and conditions for constructing the prompt sentence based on the behavior history information.

### (Supplementary 2)

The system according to supplementary 1,
wherein the processor is configured to calculate a transition index of the emotion state of the user based on time-of-day information and the behavior history information, and include, in the prompt sentence, conditions for changing a type of information to be included in the delivery character information and a transmission frequency of the audio encoding information to be registered in the transmission queue, in accordance with the transition index of the emotion state.

### (Supplementary 3)

The system according to supplementary 1,
wherein the processor is configured to input operation information and free-description information of the user, acquired from the terminal device, to the emotion estimation processing to calculate emotion intensity information, and dynamically generate a prompt sentence that specifies that the generative information processing model is to preferentially generate emotional support information, based on the emotion intensity information and the attribute information and the interest information relating to the user.

What is claimed is:

1. A system comprising:
circuitry configured to:
continuously acquire, via a communication interface coupled to a packet-switched network, post information data from an information sharing service using a public application programming interface;
execute natural language processing on text information included in the post information data, the natural language processing comprising at least morphological analysis, named entity extraction, sentiment estimation, and importance estimation, to extract structured information indicating a disaster type, an affected location, a damage content, and an urgency level;
store the structured information in association with time information, identification information, and position information in a storage device in a directly searchable format, and perform aggregation processing, classification processing, and visualization data generation processing on the stored structured information to generate disaster information display data;
transmit the disaster information display data to a terminal device via the communication interface; and
generate instruction information for a generative neural network model based on the structured information and a prompt sentence received from the terminal device, adapt the instruction information based on user attribute information and affective state information, execute inference processing using the generative neural network model with the instruction information as input, and transmit a generated result to the terminal device via the communication interface.

2. The system according to claim 1, wherein the circuitry is configured to select important information from the structured information based on an importance determination condition derived from the urgency level and the affected location, and include the selected important information in the instruction information.

3. The system according to claim 2, wherein the circuitry is configured to apply the importance determination condition by computing an importance score for each extracted record based on a combination of the urgency level, a geographic proximity metric, and a relevance weight derived from the user attribute information.

4. The system according to claim 3, wherein the circuitry is configured to adapt the prompt sentence by incorporating a field-of-interest parameter derived from the user attribute information, to cause the generative neural network model to prioritize analysis results relevant to the user's field of interest.

5. The system according to claim 4, wherein the circuitry is configured to adapt the instruction information based on the affective state information by adjusting at least one of a content presentation style and an urgency emphasis level in the prompt sentence.

6. The system according to claim 1, wherein the circuitry is configured to perform the aggregation processing by grouping structured information records by at least one of time range, region condition, and disaster type condition, and generate list information, statistical information, and geographic information as components of the disaster information display data.

7. The system according to claim 6, wherein the circuitry is configured to generate visualization data comprising geographic information by mapping position information from the stored structured information to a coordinate-based display representation.

8. The system according to claim 1, wherein the circuitry is configured to store the structured information in a document-oriented storage device enabling full-text search, and process search instructions received from the terminal device by executing query operations on the stored structured information.

9. The system according to claim 8, wherein the circuitry is configured to retrieve structured information records satisfying a search instruction specifying at least one of a disaster type, a time range, and a geographic region, and generate a search result display data for transmission to the terminal device.

10. The system according to claim 1, wherein the circuitry is configured to generate the instruction information by embedding the structured information, the user attribute information, the affective state information, and the prompt sentence into a natural language template for input to the generative neural network model.

11. The system according to claim 10, wherein the circuitry is configured to cause the generative neural network model to execute at least one of summarization processing, prioritization processing, and proposal generation processing on the structured information, and return the generated result to the terminal device.

12. The system according to claim 1, wherein the circuitry is configured to acquire audio data associated with the post information data, convert the audio data to text using speech recognition processing, and include the converted text in the natural language processing pipeline.

13. The system according to claim 12, wherein the circuitry is configured to convert the generated result into audio output data using a speech synthesis model, and transmit the audio output data to the terminal device for wireless distribution.

14. The system according to claim 1, wherein the circuitry is configured to analyze the affective state information derived from user interaction data received from the terminal device using a sentiment analysis model, and dynamically adjust the content of the instruction information based on the analyzed affective state.

15. The system according to claim 14, wherein the circuitry is configured to update the prompt sentence in subsequent inference operations to reflect changes in the affective state information over time.

16. The system according to claim 1, wherein the circuitry is configured to store the instruction information and the generated result as record information in the storage device, and update generation conditions for subsequent instruction information based on the stored record information.

17. The system according to claim 16, wherein the circuitry is configured to compute a similarity score between a vector representation of a current prompt sentence and vector representations of stored record information entries, and retrieve entries having similarity scores exceeding a threshold value for incorporation into a subsequent instruction information.

18. A system comprising:
circuitry configured to:
continuously acquire, via a communication interface coupled to a packet-switched network, post information data from an information sharing service using a public application programming interface;
execute natural language processing comprising morphological analysis, named entity extraction, sentiment estimation, and importance estimation on text information in the post information data to extract structured information indicating a disaster type, an affected location, a damage content, and an urgency level;
store the structured information with time information, identification information, and position information in a storage device, and perform aggregation processing, classification processing, and visualization data generation to generate disaster information display data for transmission to a terminal device via the communication interface;
generate instruction information by embedding the structured information, user attribute information, and affective state information into a prompt sentence, and execute inference processing using a generative neural network model with the instruction information as input to obtain a generated result; and
transmit the generated result to the terminal device via the communication interface, and store the instruction information and the generated result as record information for updating generation conditions of subsequent instruction information.

19. The system according to claim 18, wherein the circuitry is configured to apply an importance score computed from a combination of the urgency level, a geographic proximity metric, and a relevance weight to select important information from the structured information for inclusion in the instruction information.

20. A method comprising:
continuously acquiring, via a communication interface coupled to a packet-switched network, post information data from an information sharing service using a public application programming interface;
executing natural language processing on text information included in the post information data, the natural language processing comprising at least morphological analysis, named entity extraction, sentiment estimation, and importance estimation, to extract structured information indicating a disaster type, an affected location, a damage content, and an urgency level;
storing the structured information in association with time information, identification information, and position information in a storage device in a directly searchable format, and performing aggregation processing, classification processing, and visualization data generation processing on the stored structured information to generate disaster information display data;
transmitting the disaster information display data to a terminal device via the communication interface; and
generating instruction information for a generative neural network model based on the structured information and a prompt sentence received from the terminal device, adapting the instruction information based on user attribute information and affective state information, executing inference processing using the generative neural network model with the instruction information as input, and transmitting a generated result to the terminal device via the communication interface.
